(19) United States
(12) Patent Application Publication
(10) Pub. No.: US 2004/0225681 A1
(43) Pub. Date: Nov. 11, 2004

(54) Information system

(76) Inventors: Donald Lewis Chaney, Rosedale, IN (US); Ivan Samuel Paramanandam, Terre Haute, IN (US); Michael Herbert Miner, Farmersburg, IN (US)

Correspondence Address: BOSE MCKINNEY & EVANS LLP, 135 N PENNSYLVANIA ST, SUITE 2700, INDIANAPOLIS, IN, 46204, US

(21) Appl. No.: 10/435,568

(22) Filed: May 9, 2003

(51) Int. Cl. G06F 7/00

(52) U.S. Cl. 707/104.1

(57) ABSTRACT

An information system and method are provided for sharing information between a plurality of entities, such as law enforcement agencies. Further, an information system and method for issuing alerts to at least a portion of a plurality of subscribers is provided, the alerts in one example being related to law enforcement information.

### FIELD OF THE INVENTION

The present invention relates to information and alert systems, and in particular to information and alert systems for law enforcement and the community they serve.

### BACKGROUND

Law enforcement agencies need to track information related to various crimes, lists of missing persons, missing children, and wanted persons, as well as occupational information such as job openings. It is common for a county sheriff's office or other law enforcement agency to manually call other jurisdictions, such as the sheriff's office in the adjacent county to determine whether an individual is wanted in that jurisdiction. Such a system wastes county assets, is inefficient, is slow, and does not permit a law enforcement agency to leverage information collected by other law enforcement agencies without requiring placing manual calls to receive updated information. As such, a need exists for an information system that is configured to collect information from multiple law enforcement agencies and to make the collected information available to an authorized agent of a given law enforcement agency.

Additionally law enforcement agencies have used various techniques to alert members of the community of criminal suspects and missing persons or children. Example prior art systems include flyers, information printed on consumer products, such as milk cartons, and alerts through radio and television news media. However, such systems are not efficient in providing information to members of the community. As such, a need exists for an information system that is configured to collect information from multiple law enforcement agencies and to alert members of the community of recent developments, such as the abduction of a child.

### SUMMARY OF THE INVENTION

In one embodiment, an information system is provided that is configured to permit a plurality of entities, such as law enforcement agencies, to share information. In another embodiment, an information system is provided that is configured to alert a group of subscribers of an alert issued by at least one entity, such as a law enforcement agency.

In a further embodiment, a method for issuing alerts to a plurality of subscribers, each of the subscribers having access to at least one network, the alert being issued by at least one of a plurality of law enforcement agencies, each of the plurality of law enforcement agencies having a computing device configured to share information over the at least one network comprising the steps of: providing a computing device adapted to share information over the at least network, the computing device configured to access a plurality of databases including information provided by the plurality of law enforcement agencies over the at least one network; receiving alert information including an alert criteria from at least one of the plurality of law enforcement agencies over the at least one network; determining which subscribers of the plurality of subscribers are to receive the alert information based on the alert criteria; and providing an alert to the subscribers of the plurality of subscribers whom were determined to receive the alert information based on the alert criteria. In one example, the alert criteria is specified by the respective subscriber. In another example, the alert criteria is specified by the respective law enforcement agency which provided the alert information. In yet a further example, the alert criteria is selected from the group of geographical criteria, temporal criteria, and event criteria.

In yet a further embodiment an information system for issuing alerts to a plurality of subscribers, each of the subscribers having access to a network, the plurality of subscribers including a first group of subscribers associated with a first law enforcement agency and a second group of subscribers associated with a second law enforcement agency, the first and second law enforcement agencies including first and second computing devices, respectively comprising: at least a third computing device adapted to share information over the network; a plurality of databases accessible by the at least third computing device, each database including one or more records, the plurality of databases including a subscriber member database, including subscriber records related to the plurality of subscribers, each subscriber record including at least one subscriber contact address and at least one subscriber group designator; and an information management system configured to be executed by the at least third computing device. The information management system comprising: a login component configured to receive login information provided across the network from at least one of the first law enforcement agency and the second law enforcement agency and to compare the received login information to one or more user records associated with authorized personnel of at least one of the first law enforcement agency and the second law enforcement agency in a user information database to determine if the login information corresponds to at least one of the user records associated with authorized personnel of at least one of the first law enforcement agency and the second law enforcement agency; a data input component configured to receive alert data provided across the network from at least one of the first law enforcement agency and the second law enforcement agency; and an alert component configured to create an alert to be sent to subscribers which satisfy an alert criteria, the alert containing information related to the alert data provided across the network from at least one of the first law enforcement agency and the second law enforcement agency. In one example, the alert criteria is specified by the respective subscriber. In another example, the alert criteria is specified by the respective law enforcement agency which provided the alert information. In yet another example, the alert criteria is selected from the group of geographical criteria, temporal criteria, and event criteria. In one variation, the geographical criteria is defined as a circle whose center is the location of one of an accident or a crime. In another variation, the radius of the circle is set to a distance a suspect of the crime is believed to be within. In a further example, the alert criteria is a designator identifying one of the first law enforcement agency and the second law enforcement agency such that the alert is sent to the first group of subscribers when the designator identifies the first law enforcement agency and is sent to the second group of subscribers when the designator identifies the second law enforcement agency.

In still another embodiment, an information system for sharing of information between a plurality of law enforcement agencies, including a first law enforcement agency having a first computing device and a second law enforcement agency having a second computing device, both the first and second computing devices being configured to share information over at least one network, the information system, comprising: at least a third computing device adapted to share information over the at least one network; a plurality of databases accessible by the third computing device, each database including one or more records; and an information management system configured to be executed by the at least third computing device. The information management system comprising: a login component configured to receive login information provided across the at least one network and to compare the received login information to one or more user records in a user information database to determine if the login information corresponds to at least one of the user records; a data input component configured to receive data provided across the at least one network and to create or update the one or more records of one or more of the plurality of databases based on the received information; and a data searching component configured to receive a request containing search criteria provided across the network and configured to search one or more databases of the plurality of databases, the databases created or updated with the data input component based on information provided by the plurality of law enforcement agencies, for one or more records that satisfy the search criteria of the request, and to provide at least a portion of the information related to the one or more records. In one example, the information related to the one or more records is provided as a web page generated by the information management system. In another example, the data input component generates a data input form in response to receiving a request across the at least one network for the creation of a new record in at least one of the plurality of databases from one of the plurality of law enforcement agencies. In yet a further example, the plurality of databases includes at least one of a missing persons database, a missing children database, and a wanted persons database. In still a further example, the plurality of databases includes a criminal profiling database including one or more records, wherein the first law enforcement provides information related to a type of crime in a first record and the second law enforcement agency provides additional information related to the type of crime, the additional information being associated with the first record.

In still a further embodiment, a method for searching information related to at least one of a plurality of law enforcement agencies, including a first law enforcement agency having a first computing device and a second law enforcement agency having a second computing device, both the first and second computing devices being configured to provide and receive information over a network, comprising the steps of: connecting a third computing device to the network; providing a plurality of databases accessible by the third computing device and including a user information database, each database including one or more records created or modified based on information received from the first computing device and the second computing device; receiving a request from at least one of the first computing device and the second computing device containing search criteria provided across the network; searching the records created or modified based on information received from the first computing device and the second computing device of at least one of the plurality of databases for one or more records that satisfy the search criteria of the request; and providing at least a portion of the information related to the one or more records to the at least one of the first computing device and the second computing device that generated the request. In one example, the one or more records in at least one of the plurality of databases is created by the a method comprising the steps of: receiving login information provided across the network from either the first computing device or the second computing device; comparing the received login information to one or more user records in the user information database to determine if the login information corresponds to at least one of the user records; receiving a request to create a new record in a first database of the plurality of databases, the first database including records created based on information received from the first computing device and the second computing device; providing a data input mechanism configured to receive information related to the new record; receiving the information related to the new record provided to the data input mechanism; verifying that the information related to the new record satisfies a defined record structure of the first database; and updating the first database to include the new record. In one example, the provided portion of the information related to the one or more records is provided as a web page. In another example, the data input mechanism is a data input form, the data input form being configured to obtain information for the defined database structure of the first database. In yet another example, at least one of the plurality of databases is searchable across the network by a fourth computing device not affiliated with the plurality of law enforcement agencies.

### BRIEF DESCRIPTION OF THE DRAWINGS

FIG. 1 is a representation of an exemplary information system of the present invention configured to permit a plurality of law enforcement agencies to share at least some information stored in a plurality of databases with each other and the community;

FIG. 2 is a representation of the information system of FIG. 1, wherein the plurality of databases are distributed;

FIG. 3 is a representation of another exemplary information system of the present invention configured to permit a plurality of law enforcement agencies to share at least some information stored in a plurality of databases with each other and the community;

FIG. 4 is a representation of a information management system configured to manage the information in the plurality of databases;

FIG. 5 is a representation of a plurality of exemplary databases for use in a law enforcement application of the information system of FIGS. 1 and 2 and the information system of FIG. 3;

FIG. 6 is a flowchart of an exemplary login component of the information management system of FIG. 4;

FIG. 7 is an illustration of the creation of a new record for storage in at least one of the plurality of databases of the information system of FIG. 1;

FIG. 8 is a flowchart of an exemplary record creation procedure of a data input component of the information management system of FIG. 4;

FIG. 9 is an exemplary data input form;

FIG. 10 is an illustration of the modification of an existing record for storage in at least one of the plurality of databases of the information system of FIG. 1;

FIG. 11 is a flowchart of an exemplary record modification procedure of a data input component of the information management system of FIG. 4;

FIG. 12 is an exemplary web page for a law enforcement agency;

FIG. 13 is an illustration of a first search of at least one of the plurality of databases of the information system of FIG. 1 for records that satisfy a first search criteria;

FIG. 14 is an exemplary web page generated by the information management system of FIG. 4, based in part on the records determined to satisfy the criteria of the first search of FIG. 13 by the data searching component of the information management system of FIG. 4;

FIG. 15 is an exemplary query form;

FIG. 16 is an illustration of a second search of at least one of the plurality of databases of the information system of FIG. 1 for records that satisfy a second search criteria;

FIG. 17 is an exemplary web page generated by the information management system of FIG. 4, based in part on the records determined to satisfy the criteria of the second search of FIG. 16 by the data searching component of the information management system of FIG. 4;

FIG. 18 is a flowchart of an exemplary custom query procedure of a data searching component of the information management system of FIG. 4;

FIG. 19 is a flowchart of an exemplary alert subscription procedure of an alert component of the information management system of FIG. 4;

FIG. 20 is a flowchart of an exemplary alert generation procedure of an alert component of the information management system of FIG. 4; and

FIG. 21 is a representation of a plurality of areas, each area corresponding to a respective law enforcement agency, including a plurality of subscribers.

### DETAILED DESCRIPTION

While the invention is susceptible to various modifications and alternative forms, exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

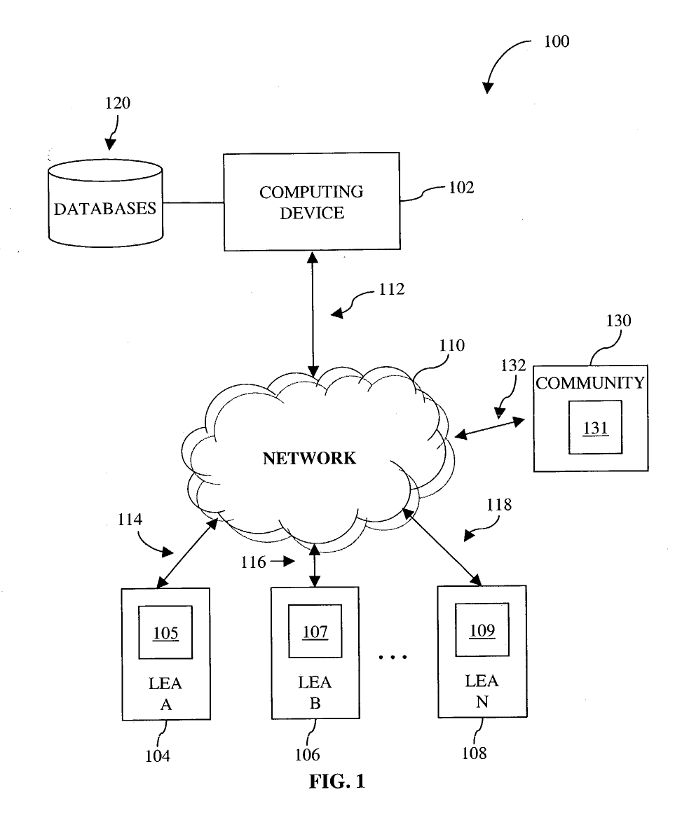

Referring to FIG. 1, an exemplary information system 100 according to the present invention is shown. Information system 100 includes a computing device 102 which is configured to receive information from and provide information to a plurality of law enforcement agencies, such as law enforcement agency A (LEA A) 104, law enforcement agency B (LEA B) 106, and law enforcement agency N (LEA N) 108, and members of a community 130 through a network 110. Information system 100, LEA 104, 106, 108, and community 130 are connected to network 110 through network connections 112, 114, 116, 118, 132 respectively. Although the exemplary embodiments of information system 100 discussed herein are tailored to the types of information related to law enforcement agencies, it is within the scope of the present invention to handle the information sharing needs of other types of agencies and other types of industries.

In one embodiment, LEA 104, 106, 108, are separate law enforcement agencies. In one example, LEA A 104 may be the Sheriff's Department for Marion County, located in the State of Indiana, LEA B 106 may be the Sheriff's Department for Johnson County, located in the State of Indiana, and LEA N 108 may be the Sheriff's Department for Hamilton County, located in the State of Indiana. Marion County, Johnson County, and Hamilton County are adjacent counties in the Indianapolis metropolitan area. In another example, LEA A 104 may be the Sheriff's Department for Marion County, located in the State of Indiana, LEA B 106 may be the Police Department for the City of Indianapolis, located in Marion County in the State of Indiana, and LEA N 108 may be the Indiana State Police. The Sheriff's Department, City of Indianapolis, and Indiana State Police have overlapping jurisdictions. In still a further example, LEA A 104 may be the Sheriff's Department for Marion County, located in the State of Indiana, LEA B 106 may be the Federal Bureau of Investigation, and LEA N 108 may be the Department of Homeland Security or a Child Welfare Services Group. As stated above, the present invention contemplates that LEA 104, 106, 108 might be any type of agencies regardless of whether the agency is related to law enforcement or not, such as US state agencies, US federal agencies, or international agencies.

Network 110 is configured to permit information system 100, LEA 104, 106, 108, and community 130 to share information. Exemplary networks include wired networks, wireless networks, such as an RF network, an IR network, a paging network, or a cellular network, local area networks, such as an Ethernet network or a token ring network, wide area networks, connections to the Internet, connections to an Intranet, combinations thereof, or other suitable networks or methods of connecting information system 100 and LEA 104, 106, 108. In a preferred embodiment, network 110 is the Internet and network connections 112, 114, 116, 118, 132 connect computing device 102, at least one computing device 105 of LEA 104, at least one computing device 107 of LEA 106, at least one computing device 109 of LEA 108, and at least one computing device 131 of community 130 to the Internet, respectively. Network connections 112, 114, 116, 118, 132 may be any suitable connection to the Internet, such as a dial-up service to an Internet Service Provider or a direct connection. Further, network connections 112, 114, 116, 118, 132 may be either wireless or wired connections.

Illustratively, network 110 is shown as a single network, however network 110 in one embodiment is comprised of two or more networks. In one example, community 130 is connected to information system 100 through a first network, such as the Internet, and LEA 104, 106, 108 is connected to information system 100 through a second network, such as a local or wide area network.

Computing device 102 receives information from and provides information to LEA 104, 106, 108 and community 130 through network 110. At least some of the information received by computing device 102 from the respective computing devices 105, 107, 109 of LEA 104, 106, 108 and the respective computing device 131 of community 130 is stored in one or more databases 120. In one example, one or more databases 120 is located on a local memory (not shown) of computing device 102, such as a hard drive. In another example, database 120 is located on a memory remote from computing device 102, but accessible by computing device 102. In one variation, the remote memory is available across network 110. In another variation, the remote memory is available across a network other than network 110, such as a local area network (not shown) of which computing device 102 is associated.

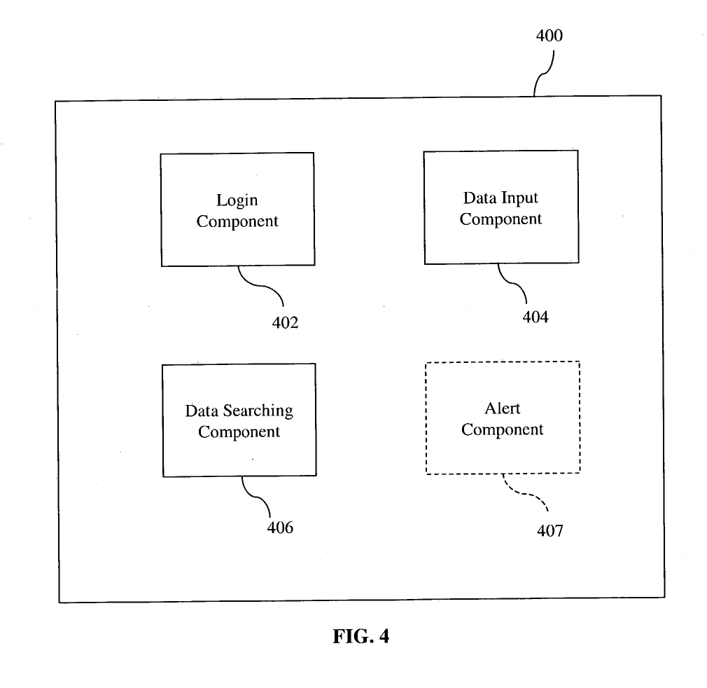

As explained in more detail below, a information management system 400 (shown in FIG. 4) is executed by computing device 102 of information system 100. Information management system 400 is configured to store information received from LEA 104, 106, 108 and community 130 in one or more databases 120, allow modification of information stored in one or more databases 120, and to allow extraction of information from one or more databases 120.

Computing devices 102, 105, 107, 109, 131 are not limited to a certain form. On the contrary, for example, computing devices 105, 107, 109, 131 may be a mainframe computer, a personal desktop computer, a server, a laptop computer, a notebook computer, a personal data assistant (PDA), a pager, a cell phone, or other suitable computing device. Exemplary PDA's include a Palm Pilot or Tungsten C both available from Palm Solutions Group located at 400 North McCarthy Blvd., Milpitas, Calif. 95035 and on the Internet at http://www.palm.com. As such, computing devices 105, 107, 109, 131 can be portable devices that LEA personnel or members of the community can take with them into the field.

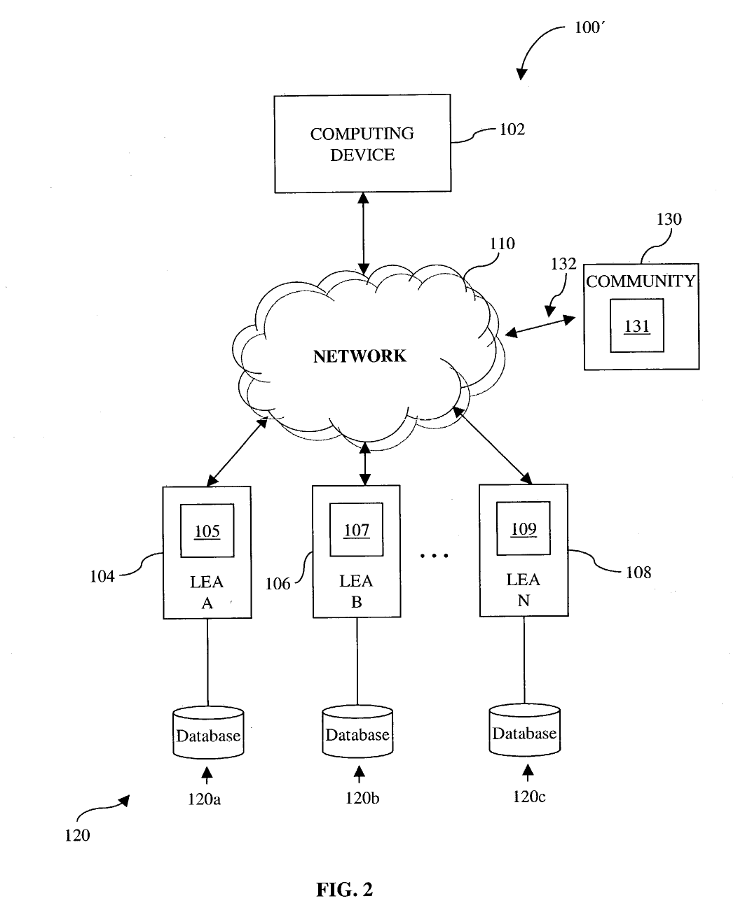

Referring to FIG. 2, an alternative embodiment of information system 100′ is shown. As shown in FIG. 2, one or more databases 120 are distributed across multiple locations, such as one or more databases 120a at LEA A 104, one or more databases 120b at LEA B 106, and one or more databases 120c at LEA C 108. In one example, the information related to the respective LEA 104, 106, 108 is stored in the corresponding one or more databases 120a, 120b, 120c and at least a portion of the information stored in one or more databases 120a, 120b, 120c is accessible by information management system 400. In another example, one or more databases 120a, 120b, 120c includes information from at least two LEA 104, 106, 108 and at least a portion of the information stored in one or more databases 120a, 120b, 120c is accessible by information management system 400.

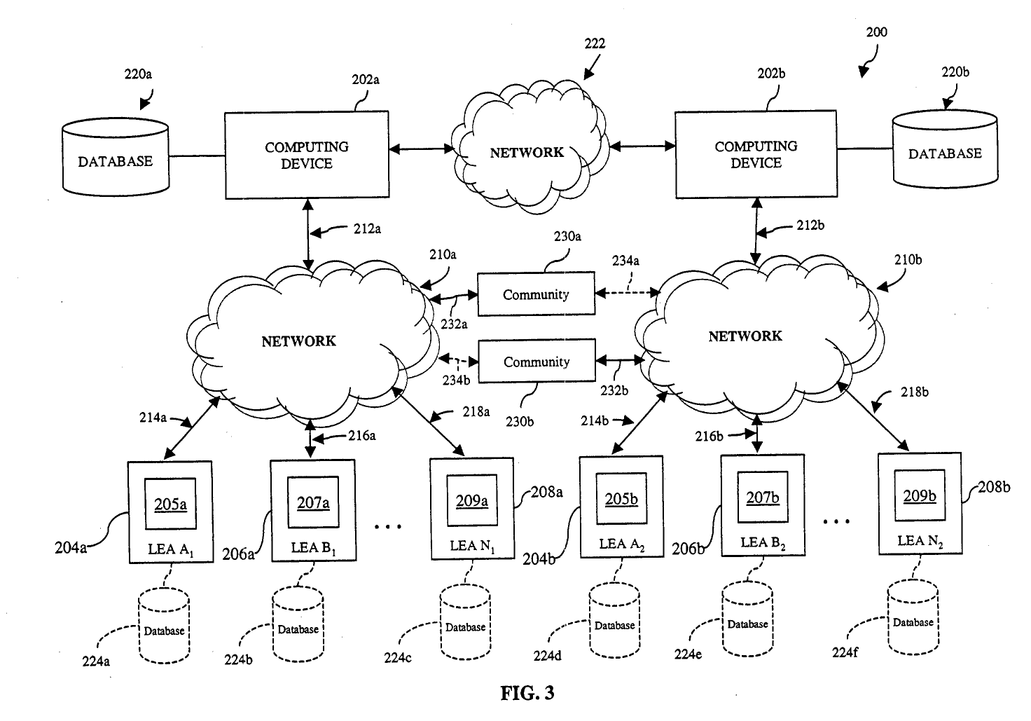

Referring to FIG. 3, another exemplary information system 200 according to the present invention is shown. Information system 200 is generally similar to information system 100 except that at least two computing devices 202a, 202b and respective one or more databases 220a, 220b replace computing device 102 and one or more databases 120. Computing devices 202a and 202b are configured to receive information from and provide information to a plurality of law enforcement agencies.

As shown in FIG. 3, computing device 202a generally receives and provides information to a plurality of law enforcement agencies, such as law enforcement agency A₁ (LEA A₁) 204a, law enforcement agency B₁, (LEA B₁) 206a, and law enforcement agency N₁, (LEA N₁) 208 through a network 210a. Computing device 202a and LEA 204a, 206a, 208a are connected to network 210a through network connections 212a, 214a, 216a, 218a, respectively. Computing device 202b generally receives and provides information to a plurality of law enforcement agencies, such as law enforcement agency A₂ (LEA A₂) 204b, law enforcement agency B₂ (LEA B₂) 206b, and law enforcement agency N₂ (LEA N₂) 208b through a network 210b. Computing device 202b and LEA 204b, 206b, 208b are connected to network 210b through network connections 212b, 214b, 216b, 218b, respectively.

Network 210a is configured to permit computing device 202a and LEA 204a, 206a, 208a to share information. Network 210a and network connections 212a, 214a, 216a, 218a are generally similar to network 110 discussed in connection with FIG. 1. Computing device 202a receives information from and provides information to LEA 204a, 206a, 208a through network 210a. At least some of the information received by computing device 202a from LEA 204a, 206a, 208a is stored in one or more databases 220a. In one example, database 220a is located on a local memory (not shown) of computing device 202a, such as a hard drive. In another example, database 220a is located on a memory remote from computing device 202a, but accessible by computing device 202a. In one variation, the remote memory is available across network 210a. In another variation, the remote memory is available across a network other than network 210a, such as a local area network (not shown) or a network 222 of which computing device 202a is associated.

Network 210b is configured to permit computing device 202b and LEA 204b, 206b, 208b to share information. Network 210b and network connections 212b, 214b, 216b, 218b are generally similar to network 110 discussed in connection with FIG. 1. Computing device 202b receives information from and provides information to LEA 204b, 206b, 208b through network 210b. At least some of the information received by computing device 202b from LEA 204b, 206b, 208b is stored in one or more databases 220b. In one example, database 220b is located on a local memory (not shown) of computing device 202b, such as a hard drive. In another example, database 220b is located on a memory remote from computing device 202b, but accessible by computing device 202b. In one variation, the remote memory is available across network 210b. In another variation, the remote memory is available across a network other than network 210b, such as a local area network (not shown) or a network 222 of which computing device 202b is associated.

Computing devices 202a and 202b are connected to network 222 such that computing devices 202a and 202b may share information. It should be understood that although networks 210a, 210b, and 222 are shown as separate networks, it is within the scope of the invention for networks 210a, 210b, 222 to be a single network, such as the Internet. By having multiple computing devices 202a and 202b, information system 200 is able to handle requests from LEAs more rapidly and is more secure because if one of computing devices 202a or 202b malfunctions or is off line the other of computing devices 202a and 202b may respond to requests from the LEAs associated with the one of computing devices 202a or 202b which malfunctioned or is off line. In one example, at least a portion of the information in databases 220a and 220b is stored in both databases 220a and 220b, such that information system 200 includes redundant data.

In an alternative embodiment of information system 200 one or more databases 220a and 220b are distributed across multiple locations, such as one or more databases 224a at LEA A₁ 204a, one or more databases 224b at LEA B₁ 206a, one or more databases 224c at LEA N1 208a, such as one or more databases 224d at LEA A₂ 204b, one or more databases 224e at LEA B₂ 206b, and one or more databases 224f at LEA N₂ 208b. In one example, the information related to the respective LEA 204a, 204b, 206a, 206b, 208a, and 208b is stored in the corresponding one or more databases 224a, 224b, 224c, 224d, 224e, and 224f and at least a portion of the information stored in one or more databases 224a, 224b, 224c, 224d, 224e, and 224f is accessible by information management system 400. In another example, one or more databases 224a, 224b, 224c, 224d, 224e, and 224f includes information from at least two LEA 204a, 204b, 206a, 206b, 208a, and 208b and at least a portion of the information stored in one or more databases 224a, 224b, 224c, 224d, 224e, and 224f is accessible by information management system 400.

Information systems 100, 100′ and 200 each permits multiple agencies or organizations to provide information to a database or collection of databases such that each agency potentially has access to both its own information and the information of other agencies. As such, each agency may search one or more of the databases for database records which are either associated with a given agency or which are associated with another agency.

Referring to FIG. 4, information systems 100, 100′ and 200 include information management system 400 which includes one or more computer programs configured to permit users to store, modify, and extract information from one or more databases, such as one or more databases 120 of information system 100, 100′ or one or more databases 220a, 220b of information system 200. Information management system 400 in one embodiment includes a login component 402, a data input component 404, and a data searching component 406. Information management system 400 in another embodiment includes a login component 402, a data input component 404, a data searching component 406, and an alert component 407.

As discussed above the databases associated with information system 100, 100′ and 200 may be located in a central location or distributed over multiple locations. Further, multiple copies of the databases or portions of the databases may be maintained at various locations. Similarly, login component 402, data input component 404, and data searching component 406 may be located in a central location or distributed over multiple locations. Further, multiple copies of information management system 400 or components of information management system 400 may be located at one or more locations. In a preferred embodiment, information management system 400 is based on the Web Data Pro, a database management software package available from Web Teacher Software, LLC located at 5405 Alton Parkway, #5A-370, Irvine, Calif. 92604-3717 and on the Internet at http://www.webteacher.com, along other database management software packages are contemplated such as database management software packages available from Oracle Corporation located at 500 Oracle Parkway, Redwood City, Calif. 94065 or on the Interent at http://www.oracle.com. It should be understood that the present invention is not limited to a given database management software package, but may use any suitable database management software package including relational, network, flat, or hierarchical database management software packages.

The remainder of the disclosure is directed to the components and operation of information management system 400 which may be a part of information systems 100, 100′ and 200. As such, for convenience the components and operation of information management system 400 is described in connection with information system 100, 100′. However, it should be understood that the following description is also applicable to information system 200.

Login component 402 is configured to control access to a portion of the information stored in one or more databases 120 and/or to control access to the ability to input information into one or more databases 120. Data input component 404 is configured to allow a user, either personnel of LEA 104, 106, 108 or members of community 130, to input new information or modify existing information in one or more databases 120 based in part on the login privileges of the user. It should be noted that some information may be added to databases 120 or current information stored in databases 120 may be modified without the user first completing login component 402. Data searching component 406 is configured to permit a user either personnel of LEA 104, 106, 108 or members of community 130, to search the information contained in at least one of databases 120 based in part on the login privileges of the user. It should be noted that some information in databases 120 may be searched without the user first completing login component 402. Further, information management system 400 extracts information from one or more databases 120 by either receiving or formulating a query. In one example, information management system 400 uses a structured query language (SQL). Other suitable query languages are also within the scope of the present invention.

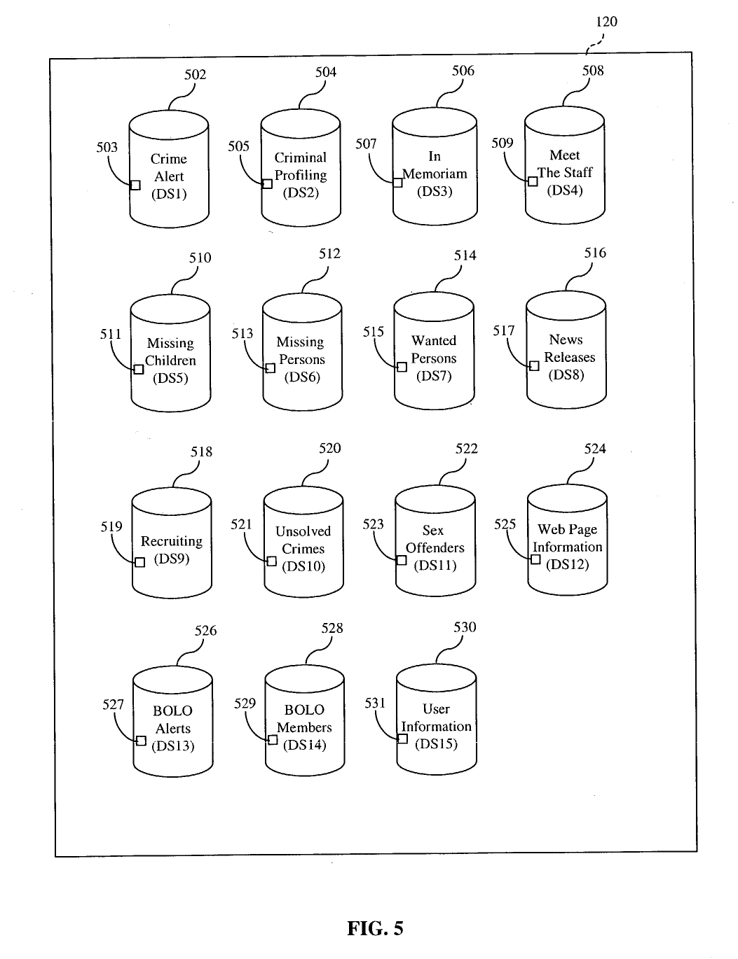

As stated previously one or more databases 120 or one or more databases 120a, 120b, 120c of information system 100, 100′ contain information related at least to one of LEA 104, 106, 108. Referring to FIG. 5, in a law enforcement application databases 120, in one example, include the following exemplary databases: crime alert database (DS1) 502, criminal profiling database (DS2) 504, in memoriam database (DS3) 506, meet the staff database (DS4) 508, missing children database (DS5) 510, missing persons database (DS6) 512, wanted persons database (DS7) 514, news release database (DS8) 516, recruiting database (DS9) 518, unsolved crimes database (DS10) 520, sex offenders database (DS11) 522, web page information database (DS12) 524, be on look out (BOLO or E-BOLO) alert database (DS13) 526, BOLO member database (DS14) 528, and user information database (DS15) 530. It should be noted that the above-mentioned databases are merely exemplary, and additional or different databases are contemplated by the present invention. Further, the structure of each database, such as number, type, and size of fields for a given record in the above-mentioned databases are exemplary and additional or fewer fields along with different field characteristics are contemplated.

Crime alert database (DS1) 502 is configured to organize data related to crime alerts issued by at least one of LEA 104, 106, 108. The crime alert data is stored in crime alert records such as crime alert record 503 created by and/or modified by personnel of LEA 104, 106, 108. In one example crime alert records 503 are modifiable by personnel of the respective LEA 104, 106, 108 that created the crime alert record 503. In another example, one or more of LEA 104, 106, 108 can modify crime alert record 503.

Crime alert database 502 is available and searchable by community 130 and LEA 104, 106, 108.

An exemplary crime alert record is shown in Table 1. As shown in Table 1 each exemplary crime alert record includes various data fields, each data field having a name (Field name), a data type (Field Type), such as character or number, and an associated field size characteristic (Field Size).

TABLE 1
Exemplary Crime Alert Record
Crime Alert Record

| Field Name | Field Type | Field Size |
|---|---|---|
| Crime Alert Date | character | 20 |
| Crime Alert Title | character | 30 |
| Submitted By | character | 20 |
| Office | character | Unlimited |
| County | character | 20 |
| City | character | 20 |
| State | character | 20 |
| Phone | character | 20 |
| E-Mail | character | 20 |
| Short Description | character | 60 |
| Detailed Description | character | 20 |
| Alert_image1 | object | 100K |
| Alert_image2 | object | 100K |

As shown in Table 1, the exemplary crime alert record contains the following fields: “Crime Alert Date” which corresponds to the date the crime alert was issued by an LEA, “Crime Alert Title” which corresponds to the title of the crime alert, “Submitted by” which corresponds to one of the LEA submitting the crime alert or an agent of the LEA submitting the crime alert, “Office” which corresponds to one of the LEA submitting the crime alert or a specific office or department within the LEA, “County” “City” and “State” which correspond to the geographical location of the LEA, “Phone” and “E-Mail” which correspond to contact information for the LEA, “Short Description” which corresponds to a short version of the crime alert, “Detailed Description” which corresponds to a more in depth description of the crime alert, and “Alert_image1” and “Alert_image2” which correspond to image files related to the crime alert.

Criminal profiling database (DS2) 504 is configured to organize data related to certain types of crimes that at least one LEA 104, 106, 108 is requesting assistance with one or more of the remaining LEA 104, 106, 108, such as similar criminal profiles. For example, LEA 104 enters or modifies the criminal profiling data into criminal profiling records such as criminal profiling record 505. The criminal profiling data entered or modified by LEA 104 is available and searchable by at least one of LEA 106, 108. In one example, criminal profiling records 505 are modifiable by the personnel of the LEA that created the record 505, in this example LEA 104. In another example, criminal profiling records 505 are modifiable by LEA 104, and at least one of LEA 106, 108.

Criminal profiling database 504 is an example of a back end feature of information systems 100, 100′ and 200 which are defined as the portions of information systems 100, 100′ and 200 that are only accessible by LEA 104, 106, 108, not the community 130. Criminal profiling database 504 is provided as an example of a back end feature. The present invention contemplates providing additional back end accessible databases configured similar to the criminal profiling database for the sharing of interdepartmental communications between LEAs 104, 106, 108, such as a photo spread database configured to share mug shots between LEAs 104, 106, 108 for photo identification of suspects by witnesses (a given LEA may pull photos from the database based on characteristics of the suspect such as race, scars, weight and other physical characteristics of the suspect) and a personal identification markers database configured to share personal identification markers between LEAs 104, 106, 108, such as voice files, voice identifiers, fingerprints, fingerprint identifiers, DNA information, DNA identifiers, and other types of information used to determine the identity of individuals. In one example of the photo spread database, a web page is generated that contains a photo spread based on the mug shots selected by the LEA personnel provided as a result of searching the photo spread database, the searching function of information systems 100, 100′ and 200 is discussed herein.

In one embodiment, the LEAs not creating the criminal profiling record, such as LEAs 106, 108 are not able to modify the criminal profiling record information entered by LEA 104. However, LEAs 106, 108 can either provide record information for other fields of criminal profiling record or create or modify a Collaborative Information Record which is associated with a given criminal profiling record by information management system 400. As such, the integrity of the original criminal profiling record created by LEA 104 is maintained. In one example, LEA 104 may modify the information contained in the criminal profiling record, but not the information contained in the collaborative information record.

An exemplary criminal profiling record is shown in Table 2A and an exemplary collaborative information record is shown in Table 2B. As shown in Table 2 each exemplary criminal profiling record includes various data fields, each data field having a name (Field name), a data type (Field Type), such as character or number, and an associated field size characteristic (Field Size).

TABLE 2A
Exemplary Criminal Profiling Record
Criminal Profiling Record

| Field Name | Field Type | Field Size |
|---|---|---|
| Suspect_Image | object | 100K |
| Suspect First Name | character | 20 |
| Suspect Middle Name | character | 20 |
| Suspect Last Name | character | 20 |
| Suspect Alias | character | 40 |
| Suspect DOB | character | 12 |
| Race | character | Unlimited |
| Race Other | character | 20 |
| Marital status | character | Unlimited |
| Sex | character | Unlimited |
| Hair Color | character | Unlimited |
| Hair Length | character | Unlimited |
| Facial Hair | character | Unlimited |
| Eye Color | character | Unlimited |
| Height Feet | character | Unlimited |
| Height Inches | character | Unlimited |
| Weight | character | 8 |
| SCARS/MARKS/TATTOOS | character | 80 |
| Scars_Marks_Tattoo_Image | object | 100K |
| Physical Characteristics | character | 80 |
| Work status and habits | character | 80 |
| Criminal history | character | 80 |
| Officer Safety | character | 80 |
| Offender residence in relation to the crime | character | 80 |
| Medical history | character | 80 |
| Medical_History_Document | object | 100K |
| Warrants | character | 80 |
| Wanted For | character | 80 |
| Suspected Crime | character | Unlimited |
| Weapon Type | character | Unlimited |
| Weapon Type Details | character | 80 |
| Gained Entry By | character | Unlimited |
| Victim Restrained | character | Unlimited |
| Method of Operation | character | 120 |
| Suspect Vehicle | character | Unlimited |
| Suspect Vehicle Other | character | 20 |
| Vehicle Color | character | 20 |
| Vehicle Details | character | 80 |
| Suspect Approach | character | 80 |
| Time of Crimes | character | Unlimited |
| Time of Crimes Character | character | 4 |
| Location of Crimes | character | Unlimited |
| Habitual Language | character | Unlimited |
| Crime Scene Information | Checkbox | 1 |
| Available DNA Results | Checkbox | 1 |
| Available Saliva | Checkbox | 1 |
| Available Blood | Checkbox | 1 |
| Available Seamen | Checkbox | 1 |
| Available Hair | Checkbox | 1 |
| Available Fingerprint/prints | Checkbox | 1 |
| Available Shoe Print | Checkbox | 1 |
| Available Palm | Checkbox | 1 |
| Available Pry Mark Impression | Checkbox | 1 |
| Available Bite Impressions | Checkbox | 1 |
| Available Valid Handgun Permit | Checkbox | 1 |
| Available Crime Photos | Checkbox | 1 |
| Available crime scene photos | Checkbox | 1 |
| Available investigators reports | Checkbox | 1 |
| Available evidence logs and evidence | Checkbox | 1 |
| submission forms | | |
| Wanted interviews of witnesses and neighbors | Checkbox | 1 |
| Crime_Images1 | Object | 100K |
| Crime_Images2 | Object | 100K |
| Crime_Images3 | Object | 100K |
| Documentation1 | Object | 100K |
| Documemtation2 | Object | 100K |
| Documentation3 | Object | 100K |
| E-Mail | character | 1 |

As shown in Table 2A, the exemplary criminal profiling record contains the following fields: “Suspect_Image” which corresponds to an actual image of the suspect or a rendering or other drawing of a suspect; “Suspect First Name”, “Suspect Middle Name”, “Suspect Last Name”, and “Suspect Alias” correspond to the name of the suspect and other names used by the suspect or used to identify the suspect; “Suspect DOB” corresponds to the date of birth of the suspect; “Race” corresponds to the race of the suspect which is presented as a list of choices; “Race Other” is a field that receives a text value for persons whose race is not listed in the choices in the “Race” field; “Marital Status” corresponds to the martial status of the suspect; “Sex” corresponds to the gender of the suspect; “Hair Color”, Hair Length”, and “Facial Hair” correspond to the hair characteristics of the suspect; “Eye Color” corresponds to the color of the suspect's eyes; “Height Feet” and “Height Inches” correspond to the height of the suspect; “Weight” corresponds to the weight of the suspect; “SCARS/MARKS/TATTOOS” corresponds to the any known scars, distinguishing marks, or tattoos the suspect has; “Scars_Marks_Tattoo_Image” corresponds to an image file of any scars, marks, or tattoos of the suspect; “Physical Characteristics” corresponds to other physical attributes of the suspect, such as the suspect has a limp or is left-handed; “Work status and habits” corresponds to the employment history and other habits of the suspect; “Criminal history” is the criminal history of the suspect; “Officer safety” corresponds to information such as is the suspect armed and dangerous, violent, or owns a gun; “Offender residence in relation to the crime” corresponds to information related to the distance the offender is suspected to live relative to the crime, such as a thirty mile radius; “Medical history” and “Medical_History_Document” correspond to the medical history and related files associated with the suspect; “Warrants” corresponds to any outstanding warrants related to the suspect; “Wanted for” corresponds to an outstanding warrants of the suspect; “Suspected Crime” corresponds to the current crime being investigated; “Weapon Type” and “Weapon Type Details” correspond to the type of weapon used by the suspect, if any; “Gained Entry By” corresponds to how the suspect gained entry to a premises; “Victim_Restrained” corresponds to if and how a victim is restrained, such as with a rope, duck tape, or gag; “Method of Operation” corresponds to information about suspect wears a costume; “Suspect Vehicle”, “Suspect Vehicle Other”, “Vehicle Color”, and “Vehicle Details” correspond to information about a car associated with either the suspect or a crime; “Suspect Approach” corresponds to information about the approach of the suspect, such as parks in the rear or parks at a higher location; “Time of Crimes” corresponds to the time in general, such as evening, or daytime; “Time of Crimes Character” corresponds to the actual time, such as 3:00 pm; “Location of Crimes” correspond to the location of the crime; “Habitual Language” corresponds to language used by a suspect, such as slang language or other types of language; “Crime Scene Information” is a checkbox which corresponds to whether crime scene information is available; “Available DNA Results”, “Available Saliva”, “Available Blood”, “Available Seamen”, “Available Hair”, “Available Fingerprint/prints”, Available Shoe Print”, “Available Palm”, “Available Pry Mark Impression”, “Available Bite Impressions” correspond to the availability of the identified information from the crime sconce or the suspect; “Available Valid Handgun Permit” corresponds to gun permits related to the suspect; “Available Crime Photos” and “Available crime scene photos” correspond to whether crime scene pictures are available; “Available investigators reports” correspond to whether existing reports concerning the crime or suspect are available; “Available evidence logs and evidence submission forms” correspond to the availability of evidence logs and/or evidence submission forms; “Interviews of witnesses and neighbors” correspond to whether interviews of witnesses and neighbors is available; “Crime_Images1”, “Crime_Images2”, “Crime_Images3”, “Documentaion1”, “Documentation2”, and “Documentation3” are objects and correspond to files, text files, audio files, video files, security camera pictures, pictures, and other types of files associated with the crime or the suspect; and “E-Mail” is the e-mail or the contact address of the agent or agency creating the record.

TABLE 2B
Exemplary Collaborative Information Record
Collaborative Information Records

| Field Name | Field Type | Field Size |
|---|---|---|
| Agent Name | character | 20 |
| Agency Name | character | 20 |
| Agent E-mail | character | 1 |
| Agent Comments | character | Unlimited |
| Documentation4 | Object | 100K |

As shown in Table 2B, the exemplary Collaborative Information record contains the following fields: “Agent Name” which corresponds to the name of the agent posting the collaborative information; “Agency Name” corresponds to the name of the agency posting the collaborative information; “Agent E-Mail” corresponds to the e-mail or contact address of the agent posting the collaborative information; “Agent Comments” corresponds to comments the agent posts related to the collaborative information; and “Documentation4” corresponds to one or more objects, such as files, text files, audio files, video files, security camera pictures, pictures, and other types of files associated with the collaborative information, crime or the suspect.

In memoriam database (DS3) 506 is configured to organize data related to information on Law Enforcement Agents killed in the line of Duty. The In Memoriam data is stored in In Memoriam records such as in memoriam record 507 created and/or modified by personnel of one of LEA 104, 106, 108. In Memoriam database 506 is available and searchable by community 130 and LEA 104, 106, 108. In one example, In Memoriam records 507 are modifiable by personnel of the respective LEA 104, 106, 108 that created the In Memoriam record 507. In another example, one or more of LEA 104, 106, 108 can modify In Memoriam record 507.

An exemplary In Memoriam record is shown in Table 3. As shown in Table 3 each exemplary In Memoriam record includes various data fields, each data field having a name (Field name), a data type (Field Type), such as character or number, and an associated field size characteristic (Field Size).

TABLE 3
Exemplary In Memoriam Record
In Memoriam Record

| Field Name | Field Type | Field Size |
|---|---|---|
| Officer Title | character | 20 |
| Officer First Name | character | 20 |
| Middle Name | character | 20 |
| Last Name | character | 20 |
| Badge Number | character | 10 |
| Date Appointed | character | 10 |
| County | character | 20 |
| State | character | Unlimited |
| Date of Birth | character | 10 |
| Date of Death | character | 10 |
| Image | object | 100K |
| Reporting Agency | character | Unlimited |
| City | character | 20 |
| image2 | object | 100K |

As shown in Table 3, the exemplary In Memoriam record contains the following fields: “Officer Title” which corresponds to the rank of the officer; “Officer First Name” “Middle Name” “Last Name” which corresponds to the name of the officer; “Badge Number” which corresponds to the badge number of the officer; “Date Appointed” which corresponds to the date the officer joined the agency; “County” and “State” which corresponds to the location of the agency; “Date of Birth” is the date of birth of the officer; “Date of Death” which corresponds to the date the officer died; “Image” which corresponds to an image of the officer; “Reporting Agency” which corresponds to the agency the officer is assigned; “City” which corresponds to the city the officer died in, resided in, or the city the agency is located in; and “Image2” corresponds to another object file which as stated before may contain one or types of files.

Meet the staff database (DS4) 508 is configured to organize data related to information on Officers and Staff members, along with their responsibilities or credentials, within each of LEA 104, 106, 108. The meet the staff data is stored in meet the staff records such as meet the staff record 509 created and/or modified by personnel of one of LEA 104, 106, 108. Meet the staff database 508 is available and searchable by community 130 and LEA 104, 106, 108. In one example, meet the staff records 509 are modifiable by personnel of the respective LEA 104, 106, 108 that created the meet the staff record 509. In another example, one or more of LEA 104, 106, 108 can modify meet the staff record 509.

An exemplary meet the staff record is shown in Table 4. As shown in Table 4 each exemplary meet the staff record includes various data fields, each data field having a name (Field name), a data type (Field Type), such as character or number, and an associated field size characteristic (Field Size).

TABLE 4
Exemplary Meet the Staff Record
Meet the Staff Record

| Field Name | Field Type | Field Size |
|---|---|---|
| Name | character | 20 |
| Title | character | 20 |
| Duties | character | 20 |
| Description | character | 4 |
| Image | object | 30K |
| State | character | Unlimited |
| County | character | 20 |
| Web Developer | checkbox | 1 |
| Badge Suffix | character | 8 |
| Badge Prefix | character | 2 |
| Thumbnail | object | 100K |
| More_Info_Right_Image | object | 100K |
| More_Info_Left_Image | object | 100K |
| E-mail Address | character | 1 |
| Law enforcement graduating class # | character | 8 |
| Agency | character | Unlimited |
| City | character | 30 |
| Deceased | character | 20 |
| Term | character | 20 |

As shown in Table 4, the exemplary Meet the Staff record contains the following fields: “Name” which corresponds to the name of the staff member; “Title” which corresponds to the title associated with the staff member, such as clerk or deputy; “Duties” which corresponds to the duties of the staff member; “Description” which corresponds to additional information about the staff member; “Image” which is an image of the staff member; “State” and “County” correspond to the location the staff member works at; “Web Developer” corresponds to whether an independent web developer assisted in the development of the page that contains the staff information, if so the web developer may be given credit; “Badge Suffix” and “Badge Prefix” which corresponds to information about the badge number of the staff member; “Thumbnail” which corresponds to a small image of the staff member; “More_Info_Right_Image” and “More_Info_Left_Image” correspond to objects that are used as buttons on the associated web page to request additional information (all of the exemplary records presented may include fields for buttons like “More_Info_Right_Image” and “More_Info_Left_Image”); “E-Mail Address” corresponds to the e-mail or contact address of the staff member; “Law enforcement graduating class #” corresponds to at least one of the year the staff member graduated or the class rank of the staff member”; “Agency” corresponds to the agency the staff member is associated with; “City” corresponds to the city the staff member works in; “Deceased” corresponds to whether the staff member is alive or dead; and “Term” corresponds to the information concerning years of service, such as for an elected position how many terms the staff member has served.

Missing children database (DS5) 510 is configured to organize data related to information on missing children. The missing children data is stored in missing children records such as missing children record 511 created and/or modified by personnel of one of LEA 104, 106, 108. Missing children database 510 is available and searchable by community 130 and LEA 104, 106, 108. In one example, missing children record 511 are modifiable by personnel of the respective LEA 104, 106, 108 that created the missing children record 511. In another example, one or more of LEA 104, 106, 108 can modify missing children record 511.

An exemplary missing children record is shown in Table 5. As shown in Table 5 each exemplary missing children record includes various data fields, each data field having a name (Field name), a data type (Field Type), such as character or number, and an associated field size characteristic (Field Size).

TABLE 5
Exemplary Missing Children Record
Missing Children

| Field Name | Field Type | Field Size |
|---|---|---|
| Childs Name - First | character | 20 |
| Childs Name - Last | character | 20 |
| Missing Type | character | Unlimited |
| Missing From - City | character | 20 |
| Missing From - State | character | Unlimited |
| Missing From - Zip | character | 12 |
| County | character | 20 |
| Date Missing | character | 20 |
| Date Of Birth | character | 10 |
| Sex | character | Unlimited |
| Age | character | 4 |
| Hair Color | character | Unlimited |
| Eye Color | character | Unlimited |
| MP_Image | object | 200 |
| MP_Poster_Image | object | 200 |
| MP_Aged_Poster_Image | object | 300 |
| Abductor First Name | character | 20 |
| Abductor Last Name | character | 20 |
| Abductor Sex | character | Unlimited |
| Abductor Hair Color | character | Unlimited |
| Abductor Eye Color | character | Unlimited |
| Abductor Date of Birth | character | 10 |
| Abductor Height Feet | character | 5 |
| Abductor Height Inches | character | 20 |
| Abductor Weight | character | 4 |
| Abductor Additional Information | character | 60 |
| Agency Contact | character | 60 |
| Contact Phone | character | 20 |
| Last Seen | character | 60 |
| Agency | character | Unlimited |
| City | character | 20 |
| State | character | Unlimited |
| County | character | 20 |

As shown in Table 5, the exemplary Missing Children record contains the following fields: “Childs Name—First” and “Childs Name—Last” which correspond to the name of the missing child; “Missing Type” is a droplist that provides exemplary types of missing children, such as stranger abduction, friend abduction, family member abduction; “Missing From—City”, “Missing From—State”, “Missing From—Zip”, and “County” correspond to the location the child is missing from; “Date Missing” corresponds to the date the child was reported or was noticed to be missing; “Date of Birth” corresponds to the date of birth of the child; “Sex” corresponds to the sex of the child; “Age” corresponds to the age of the child; “Hair Color” corresponds to the hair color of the child; “Eye Color” corresponds to the eye color of the child; “MP_Image” corresponds to an image of the missing child; “MP_Poster_Image” corresponds to an image of the child which is to be used for a missing child poster; “MP_Aged_Poster_Image” corresponds to an image which attempts to illustrate how the child might look at a later time, such as today; “Abductor First Name” and “Abductor Last Name” which correspond to the name of the Abductor; “Abductor Sex” which corresponds to the sex of the abductor; “Abductor Hair Color” which corresponds to the hair color of the abductor; “Abductor Eye Color” which corresponds to the eye color of the abductor; “Abductor Date of Birth” which corresponds to the date of birth of the abductor; “Abductor Height Feet” and Abductor Height Inches” which correspond to the height of the abductor; “Abductor Weight” which corresponds to the weight of the Abductor; “Abductor Additional Information” which corresponds to additional information related to the abductor; “Agency Contact” which corresponds to the contact at the agency posting the record or how to contact the agency posting the record; “Contact Phone” corresponds to a contact address, such as the phone number of the contact; “Last Seen” corresponds to location and/or time the child was last seen; “Agency” corresponds to the agency posting the contact; and “City”, “State”, and “County” correspond to the location of the agency.

Missing persons database (DS6) 512 is configured to organize data related to information on missing persons. The missing persons data is stored in missing persons records such as missing person record 513 created and/or modified by personnel of one of LEA 104, 106, 108. Missing persons database 512 is available and searchable by community 130 and LEA 104, 106, 108. In one example, missing person record 513 is modifiable by personnel of the respective LEA 104, 106, 108 that created the missing person record 513. In another example, one or more of LEA 104, 106, 108 can modify missing person record 513.

An exemplary missing persons record is shown in Table 6. As shown in Table 6 each exemplary missing persons record includes various data fields, each data field having a name (Field name), a data type (Field Type), such as character or number, and an associated field size characteristic (Field Size).

TABLE 6
Exemplary Missing Persons Record
Missing Persons

| Field Name | Field Type | Field Size |
|---|---|---|
| First Name | character | 20 |
| Last Name | character | 20 |
| Middle Name | character | 20 |
| Sex | character | Unlimited |
| Birth Date | character | 20 |
| Height Feet | character | Unlimited |
| Height Inches | character | Unlimited |
| Build | character | 20 |
| Complexion | character | 20 |
| Hair Color | character | Unlimited |
| Eye Color | character | Unlimited |
| Date Last Seen | character | 20 |
| Location Last Seen | character | 80 |
| Missing_Person_Icon | object | 100K |
| Missing_Person_Image | object | 100K |
| Age When Picture Was Taken | character | 80 |
| Contact If Seen | character | 40 |
| County | character | 20 |
| State | character | Unlimited |
| Phone | character | 12 |

As shown in Table 6, the exemplary Missing Persons record contains the following fields: “First Name”, “Last Name”, and “Middle Name” correspond to the name of the missing person; “Sex” corresponds to the sex of the missing person; “Birth Date” corresponds to the date of birth of the missing person; “Height Feet” and “Height Inches” corresponds to the height of the missing person; “Build” corresponds to the physical build of the missing person; “Complexion” which corresponds to the complexion of the missing person; “Hair Color” which corresponds to the hair color of the missing person; “Eye Color” which corresponds to the eye color of the missing person; “Date Last Seen” which corresponds to the date and or time the missing person was last seen; “Location Last Seen” which corresponds to the last location the missing person was seen; “Missing_Person_Icon” is an image file similar to a thumbnail image of the missing person; “Missing_Person_Image” is an image file of an image of the missing person; “Age When Picture Was Taken” corresponds to the time frame the image of the missing person was taken; and “Contact If See” corresponds to the agency or contact to contact with information regarding the missing person.

Wanted persons database (DS7) 512 is configured to organize data related to information on persons with outstanding warrants. The wanted persons data is stored in wanted persons records such as wanted person record 515 created and/or modified by personnel of one of LEA 104, 106, 108. Wanted persons database 512 is available and searchable by community 130 and LEA 104, 106, 108. In one example, wanted person record 515 are modifiable by personnel of the respective LEA 104, 106, 108 that created the wanted person record 515. In another example, one or more of LEA 104, 106, 108 can modify wanted person record 515.

An exemplary wanted persons record is shown in Table 7. As shown in Table 7 each exemplary crime wanted persons includes various data fields, each data field having a name (Field name), a data type (Field Type), such as character or number, and an associated field size characteristic (Field Size).

TABLE 7
Exemplary Wanted Person Record
Wanted Persons

| Field Name | Field Type | Field Size |
|---|---|---|
| FIRST NAME | character | 20 |
| LAST NAME | character | 20 |
| ALIAS | character | 20 |
| DOB | character | 8 |
| RACE | character | Unlimited |
| SEX | character | Unlimited |
| HAIR COLOR | character | Unlimited |
| EYE COLOR | character | Unlimited |
| HEIGHT FEET | character | Unlimited |
| HEIGHT INCHES | character | Unlimited |
| WEIGHT | character | 4 |
| SCARS/MARKS/TATTOOS | character | 20 |
| WARRENT NUMBER | character | 20 |
| BOND | character | 12 |
| WANTED FOR | character | 60 |
| CAUTION | character | 20 |
| ADDITIONAL INFORMATION | character | 60 |
| STATE | character | 20 |
| COUNTY | character | 20 |
| LARGE_IMAGE | object | 100K |
| Contact Info. | character | 40 |
| Contact Phone | character | 20 |
| City | character | 20 |
| Race Other | character | 20 |
| Last Seen | character | 80 |
| Middle Name | character | 20 |
| Submitted by | character | 20 |
| Disposition | character | Unlimited |
| Disposition Date | character | 20 |
| Crime Stopper Featured | checkbox | 1 |
| Crime Stoppers Region | character | Unlimited |
| Agency | character | Unlimited |
| Additional Warrants | character | 120 |
| Scars/Marks/Tatoos | object | 100K |
| wanted_thumbnail | object | 100K |

As shown in Table 7, the exemplary Wanted Persons record contains the following fields: “FIRST NAME”, “Middle Name” and “LAST NAME” which correspond to the name of the wanted person; “ALIAS” which corresponds to any assumed names or other names of the wanted person; “DOB” corresponds to the date of birth of the wanted person; “RACE” and “Race Other” corresponds to the race of the wanted person; “SEX” corresponds to the sex of the wanted person; “HAIR COLOR” corresponds to the hair color of the wanted person; “EYE COLOR” corresponds to the eye color of the wanted person; “HEIGHT FEET” and “HEIGHT INCHES” correspond to the height of the wanted person; “WEIGHT” corresponds to the weight of the wanted person; “SCARS/MARKS/TATTOOS” corresponds to any scars, marks, tattoos, or other identifying marks the wanted person has; “WARRANT NUMBER” corresponds to the number of the warrant issued for the wanted person; “BOND” corresponds to information related to any outstanding bonds; “WANTED FOR” corresponds to what charges the wanted person is wanted in connection with; “CAUTION” corresponds to information about the wanted person such as armed and dangerous, violent, or that the wanted person owns a gun; “ADDITIONAL INFORMATION” corresponds to any additional information related to the wanted person; “STATE” and “COUNTY” correspond to the location related to the warrant; “LARGE_IMAGE” corresponds to an image of the wanted person, such as a photograph or drawing; “Contact Info.” relates to the agent to contact with information concerning the wanted person; “Contact Phone” corresponds to the contact address, such as a phone number of the contact; “City” corresponds to a location of the agency; “Last Seen” corresponds to information related to the time and/or place the wanted person was last seen; “Submitted by” is the name of the individual or agency which submitted the wanted person record; “Disposition” relates to the outcome of the investigation; “Disposition Date” corresponds to the date the investigation was closed; “Crime Stopper Featured” is a checkbox to indicate whether the wanted person has been featured in crime stoppers; “Crime Stoppers Region” corresponds to information related to the region the crime stopper information was received from or sent to; “Agency” corresponds to the agency submitting the record; “Additional Warrants” correspond to other outstanding warrants of the wanted person; “Scars/Marks/Tatoos” is an object file corresponding to information about the wanted persons scars, marks, or tattoos, such as a picture of a tattoo; and “wanted_thumbnail” which corresponds to a thumbnail image of the wanted person.

News release database (DS8) 516 is configured to organize data related to news releases issued by or obtained by at least one of LEA 104, 106, 108. The news release data is stored in news release records such as news release record 517 created and/or modified by personnel of one of LEA 104, 106, 108 and is available and searchable by community 130 and LEA 104, 106, 108. In one example, news release record 517 are modifiable by personnel of the respective LEA 104, 106, 108 that created the news release record 517. In another example, one or more of LEA 104, 106, 108 can modify news release record 517.

An exemplary news release record is shown in Table 8. As shown in Table 8 each exemplary news release record includes various data fields, each data field having a name (Field name), a data type (Field Type), such as character or number, and an associated field size characteristic (Field Size).

TABLE 8
Exemplary News Release Record
News Release Record

| Field Name | Field Type | Field Size |
|---|---|---|
| News Release Date | character | 20 |
| News Release Title | character | 30 |
| Submitted By | character | 20 |
| Office | character | Unlimited |
| County | character | 20 |
| City | character | 20 |
| State | character | 20 |
| Phone | character | 20 |
| E-Mail | character | 20 |
| Short Description | character | 60 |
| Detailed Description | character | 400 |
| nr_image1 | object | 100K |
| nr_image2 | object | 100K |

As shown in Table 8, the exemplary News Release record contains the following fields: “News Release Date” which corresponds to the date of the new release; “News Release Title” which corresponds to a title of the news release; “Submitted By” corresponds to the agency or individual submitting the news release; “Office”, “City”, “County”, “State” correspond to the location of the agency or individual submitting the record; “Phone” and “E-Mail” correspond to the contact information for the agency or an individual; “Short Description” corresponds to a brief description of the news release; “Detailed Description” corresponds to a more detailed description of the news release; and “nr_image1” and “nr_image2” correspond to images related to the news release.

Recruiting database (DS9) 518 is configured to organize data related to employment opportunities at one of LEA 104, 106, 108. The recruiting data is stored in recruiting records such as recruiting record 519 created and/or modified by personnel of one of LEA 104, 106, 108. Recruiting database 518 is available and searchable by community 130 and LEA 104, 106, 108. In one example, as recruiting record 519 are modifiable by personnel of the respective LEA 104, 106, 108 that created the as recruiting record 519. In another example, one or more of LEA 104, 106, 108 can modify as recruiting record 519.

An exemplary recruiting record is shown in Table 9. As shown in Table 9 each exemplary recruiting record includes various data fields, each data field having a name (Field name), a data type (Field Type), such as character or number, and an associated field size characteristic (Field Size).

TABLE 9
Exemplary Recruiting Record
Recruiting Record

| Field Name | Field Type | Field Size |
|---|---|---|
| Job Opportunity | Character | 20 |
| Description | Character | 80 |
| Contact | Character | 20 |
| Address1 | Character | 20 |
| Address2 | Character | 20 |
| City | Character | 20 |
| State | Character | Unlimited |
| Zip | Character | 20 |
| County | Character | 20 |
| Phone | Character | 20 |

As shown in Table 9, the exemplary Recruiting record contains the following fields: “Job Opportunity” corresponds to a title of the job opening; “Description” corresponds to a description of the job opening; “Contact” corresponds to the person to contact regarding the job opening; and “Address1”, “Address2”, “City”, “State”, “Zip”, “County”, “Phone” correspond to location and contact information for the agency with the job opening.

Unsolved crimes database (DS10) 520 is configured to organize data related to existing open investigations or cases at one of LEA 104, 106, 108. In one example, the unsolved crimes data corresponds to old or cold cases. The unsolved crimes data is stored in unsolved crimes records such as unsolved crime record 521 created and/or modified by personnel at one of LEA 104, 106, 108. Unsolved crimes database 520 is available and searchable by community 130 and LEA 104, 106, 108. In one example, unsolved crime record 521 are modifiable by personnel of the respective LEA 104, 106, 108 that created the unsolved crime record 521. In another example, one or more of LEA 104, 106, 108 can modify unsolved crime record 521.

An exemplary unsolved crime record is shown in Table 10. As shown in Table 10 each exemplary unsolved crime record includes various data fields, each data field having a name (Field name), a data type (Field Type), such as character or number, and an associated field size characteristic (Field Size).

TABLE 10
Exemplary Unsolved Crime Record
Unsolved Crimes

| Field Name | Field Type | Field Size |
|---|---|---|
| Crime Type | character | Unlimited |
| Vehicle Type | character | Unlimited |
| Crime Title | character | 40 |
| Crime Date | character | 20 |
| Crime Time | character | 20 |
| Crime Location | character | 120 |
| City | character | 20 |
| State | character | 20 |
| County | character | 20 |
| Alert Title | character | 60 |
| Crime Details | character | 120 |
| image1 | object | 100K |
| Video_Audio | object | 20000 |
| Video_Audio Information | character | 80 |
| Submitted By | character | 40 |

As shown in Table 10, the exemplary Unsolved crimes record contains the following fields: “Crime Type” corresponds to the type of crime; “vehicle type” corresponds to the type of vehicle used by the suspect, such as a getaway car or a car that was stolen; “Crime Title” corresponds to a title of the crime; “Crime Date” and “Crime Time” correspond to the date and time of the crime; “Crime Location” corresponds to the location of the crime, such as a building or address or street corner; “City”, “State”, and “County” corresponds to one of the location of the crime or the location of the agency reporting the crime; “Alert Title” corresponds to the title of an alert issued related to the unsolved crime; “Crime Details” corresponds to additional information about the crime; “Image1” corresponds to an image of the crime scene, vehicle or related photo; “Video_Audio” corresponds to an audio file and/or video file related to the crime, such as a security camera tape; “Video_Audio Information” corresponds to information about the corresponding video and/or audio file; “Submitted By” corresponds to the agency or individual submitting the unsolved crime information.

Sex offenders database (DS11) 522 is configured to organize data related to registered sex offenders at one of LEA 104, 106, 108. The sex offender data is stored in sex offenders records such as sex offender record 523 created and/or modified by personnel of one of LEA 104, 106, 108. Sex offenders database 522 is available and searchable by community 130 and LEA 104, 106, 108. In one example, sex offender record 523 are modifiable by personnel of the respective LEA 104, 106, 108 that created the sex offender record 523. In another example, one or more of LEA 104, 106, 108 can modify sex offender record 523.

An exemplary sex offender record is shown in Table 11. As shown in Table 11 each exemplary sex offender record includes various data fields, each data field having a name (Field name), a data type (Field Type), such as character or number, and an associated field size characteristic (Field Size).

TABLE 11
Exemplary Sex Offender Record
Sex Offender Record

| Field Name | Field Type | Field Size |
|---|---|---|
| Type | character | 20 |
| First Name | character | 20 |
| Last Name | character | 20 |
| Middle Name | character | 10 |
| Alias(es) | character | 20 |
| Race | character | Unlimited |
| Sex | character | Unlimited |
| Hair Color | character | Unlimited |
| Eye Color | character | Unlimited |
| Height Feet | character | Unlimited |
| Height Inches | character | Unlimited |
| Weight | character | 8 |
| Physical Description | character | 20 |
| Social Security No. | character | 20 |
| Drivers License No. | character | 20 |
| Date of Birth | character | 20 |
| Address 1 | character | 20 |
| Address 2 | character | 20 |
| City | character | 20 |
| State | character | Unlimited |
| County | character | 20 |
| Offense | character | 80 |
| Place of Employment | character | 20 |
| Conviction Date | character | 6 |
| Release Date | character | 20 |
| Sentence Date | character | 20 |
| Sentence | character | 20 |
| Image | object | 100K |
| Offense(s) | character | Unlimited |
| Registration Status | character | Unlimited |
| Data Entered By | character | 20 |
| Agency | character | Unlimited |
| Image_Thumb | object | 100K |
| Reporting_City | character | 20 |
| Reporting_State | character | Unlimited |
| Reporting_County | character | 20 |
| Reporting Agency Address | character | 80 |
| Phone | character | 20 |

As shown in Table 11, the exemplary Sex Offenders record contains the following fields: “Type” corresponds to a type of the sex offender; “First Name”, Last Name”, “Middle Name”, and “Alias(es)” correspond to the name of the sex offender or other names the sex offender is known by; “Race” corresponds to the race of the sex offender; “Hair Color” corresponds to the hair color of the sex offender; “Eye Color” corresponds to the eye color of the sex offender; “Height Feet” and “Height Inches” corresponds to the height of the sex offender; “Weight” corresponds to the weight of the sex offender; “Physical Description” corresponds to the other descriptions about the sex offender, such as hair length, limps, and facial hair; “Social Security No.” corresponds to the social security number of the sex offender; “Drivers License No.” corresponds to the drivers license number of the sex offender; “Date of Birth” corresponds to the date of birth of the sex offender; “Address1”, “Address2”, “City”, “State”, and “County” correspond to the location of the sex offender; “Offense” corresponds to the offense committed by the sex offender; “Place of Employment” corresponds to the location the sex offender currently is employed; “Conviction Date” corresponds to the date the sex offender was convicted; “release date” corresponds to the release date of the sex offender; “Sentence date” corresponds to the date the sex offender was sentenced; “Sentence” corresponds to the sentence the sex offender received; “Image” corresponds to a image of the sex offender; “Offense(s)” corresponds to the offense the sex offender was charged with and/or convicted of; “Registration Status” corresponds to whether the sex offender is registered and/or the location of registration; “Date Entered By” corresponds to one of a date regarding the registration of the sex offender or the date the record was created; “Agency” corresponds to the agency that created the record or the agency that the sex offender is registered with; “Image_Thumb” corresponds to a thumbnail image of the sex offender; “Reporting_City”, “Reporting_State”, “Reporting_County”, “Reporting Agency Address”, and “Phone” correspond to contact information and location of the reporting agency.

Web page information database (DS12) 524 is configured to organize data related the content of the web site associated with a given LEA 104, 106, 108. The web page information is created and/or modified by each LEA 104, 106, 108 and is stored in web page information records, such as web page information record 525, and is tailored for the community served by the respective LEA 104, 106, 108. Example web page information includes information related to an agency Home Page, Drug Task Force, Public Assistance Programs, Jail Visitation, History of the respective LEA 104, 106, 108, and Commissary. The web page information database is available and searchable by community 130 and LEA 104, 106, 108.

An exemplary web page information record is shown in Table 12. As shown in Table 12 each exemplary web page information record includes various data fields, each data field having a name (Field name), a data type (Field Type), such as character or number, and an associated field size characteristic (Field Size).

TABLE 12
Exemplary Web Page Information Record
Web Page Information Record

| Field Name | Field Type | Field Size |
|---|---|---|
| Home | htm | 1 Page |
| Jail Visitation | htm | 1 Page |
| Drug Task Force | htm | 1 Page |
| Public Assistance | htm | Multiple Pages |
| Contact Numbers | htm | 1 Page |
| Our Mission | htm | 1 Page |
| History | htm | 1 Page |

As shown in Table 12, the exemplary Web Page Information record contains the following fields: “Home” corresponding to the information related to a home page of the agency and/or location of the home page; “Jail Visitation”, “Drug Task Force”, “Public Assistance”, “Contact Numbers”, “Our Mission”, and “History” correspond to information related to or the location of web pages created by the agency and related to jail visitation regulations, drug task force news, public assistance information, contact numbers, agency mission statement, and history of the agency respectively.

BOLO alert database (DS13) 528 is configured to organize data related to alerts issued by one of LEA 104, 106, 108 to a group of community subscribers which have expressed an interest in being involved in fighting crime, such as recent child abductions and fugitives. The BOLO alert data is stored in BOLO alert records such as BOLO alert record 527 created and/or modified by one of LEA 104, 106, 108. BOLO alert database 528 is available and searchable by community 130 and LEA 104, 106, 108. In one example, BOLO alert records 527 are modifiable by personnel of the respective LEA 104, 106, 108 that created the BOLO alert record 527. In another example, one or more of LEA 104, 106, 108 can modify BOLO alert record 527.

An exemplary BOLO alert record is shown in Table 13. As shown in Table 13 each exemplary BOLO alert record includes various data fields, each data field having a name (Field name), a data type (Field Type), such as character or number, and an associated field size characteristic (Field Size).

TABLE 13
Exemplary BOLO Alert Record
BOLO Alert Record

| Field Name | Field Type | Field Size |
|---|---|---|
| Crime Type | Character | Unlimited |
| Description | Character | 10 lines |
| Posters | Object | 100K |
| Subscriber Region1 | Character | Unlimited |
| Subscriber Region2 | Character | Unlimited |
| Subscriber Region3 | Character | Unlimited |

As shown in Table 13, the exemplary BOLO Alert record contains the following fields: “Crime Type” which corresponds to the type of crime the alert relates to; “Description” corresponds to a description of the crime, suspect and/or victim; “Posters” corresponds to object files such as missing persons posters either included in the alert or accessible; “Subscriber Region 1”, “Subscriber Region 2”, and “Subscriber Region 3” which correspond to three alert criteria the subscriber has provided for receiving alerts.

BOLO members database (DS14) 528 is configured to organize data related to community subscribers who have expressed an interest in fighting crime and would like to receive alerts entered in the BOLO Alert database (DS13) 526. The BOLO members data is entered or modified into BOLO members records such as BOLO member record 529 by a member of the community and is available and searchable by the community and LEA 104, 106, 108. In one example, the BOLO members data is only searchable by LEA 104, 106, 108 such that members of the community cannot determine the persons who are listed in the BOLO database (DS14) 528.

An exemplary BOLO members record is shown in Table 14. As shown in Table 14 each exemplary BOLO members record includes various data fields, each data field having a name (Field name), a data type (Field Type), such as character or number, and an associated field size characteristic (Field Size).

TABLE 14
Exemplary BOLO Members Record
BOLO Members Record

| Field Name | Field Type | Field Size |
|---|---|---|
| Subscriber E-mail | character | 20 |
| Subscriber County | character | 20 |
| Subscriber State | character | Unlimited |
| Subscriber Region1 | character | Unlimited |
| Subscriber Region2 | character | Unlimited |
| Subscriber Region3 | character | Unlimited |

As shown in Table 14, the exemplary BOLO Members record contains the following fields: “Subscriber E-Mail” which corresponds to the contact address, such as e-mail, of the subscriber, “Subscriber County” and “Subscriber State” which correspond to the location of the subscriber; “Subscriber Region 1”, “Subscriber Region 2”, and “Subscriber Region 3” which correspond to three alert criteria the subscriber has provided for receiving alerts.

User information database (DS15) 530 is configured to organize data related to usernames, passwords and privileges for information system 100 of staff personnel at each one of LEA 104, 106, 108. The user information data is stored in user information records such as user information record 531 created and/or modified by a system administrator at each one of LEA 104, 106, 108 and is used to control access to the certain functions and areas of information system 100.

An exemplary user information record is shown in Table 15. As shown in Table 15 each exemplary user information record includes various data fields, each data field having a name (Field name), a data type (Field Type), such as character or number, and an associated field size characteristic (Field Size).

TABLE 15
Exemplary User Information Record
User Information Record

| Field Name | Field Type | Field Size |
|---|---|---|
| System Admin User Name | character | 20 |
| System Admin Password | character | 20 |
| System Admin Privileges | character | Unlimited |
| Sub Admin User Name | character | 20 |
| Sub Admin Password | character | 20 |
| Sub Admin Privileges | character | Unlimited |

As shown in Table 15, the exemplary User Information record contains the following fields: “System Admin User Name”, “System Admin Password”, and “System Admin Privileges” correspond to the username, password and privileges given to a system administrator at each agency. It is contemplated to have various levels of system administrators, each level having different privileges. “Sub Admin User Name”, “Sub Admin Password”, and “Sub Admin Privileges” correspond to the username, password and privileges given to a sub administrator at each agency. It is contemplated to have various levels of sub administrators, each level having different privileges. For example, a first group of sub administrators might only have privileges to input data and a second group might have the additional privilege to issue BOLO or APB alerts

The majority of information stored in one or more databases 120 is entered or modified by authorized personnel associated with one of LEA 104, 106, 108. Of the exemplary databases shown in FIG. 5, authorized personnel associated with one of LEA 104, 106, 108 enters or modifies the data stored in crime alert database (DS1) 502, criminal profiling database (DS2) 504, in memoriam database (DS3) 506, meet the staff database (DS4) 508, missing children database (DS5) 510, missing persons database (DS6) 512, wanted persons database (DS7) 514, news release database (DS8) 516, recruiting database (DS9) 518, unsolved crimes database (DS10) 520, sex offenders database (DS11) 522, web page information database (DS12) 524, BOLO alert database (DS13) 526, and user information database (DS15) 530. Members of community 130 enter or modify information in the BOLO alert database (DS14) 528. In an alternate embodiment authorized personnel associated with one of LEA 104, 106, 108 enters or modifies information in the BOLO alert database (DS14) 528.

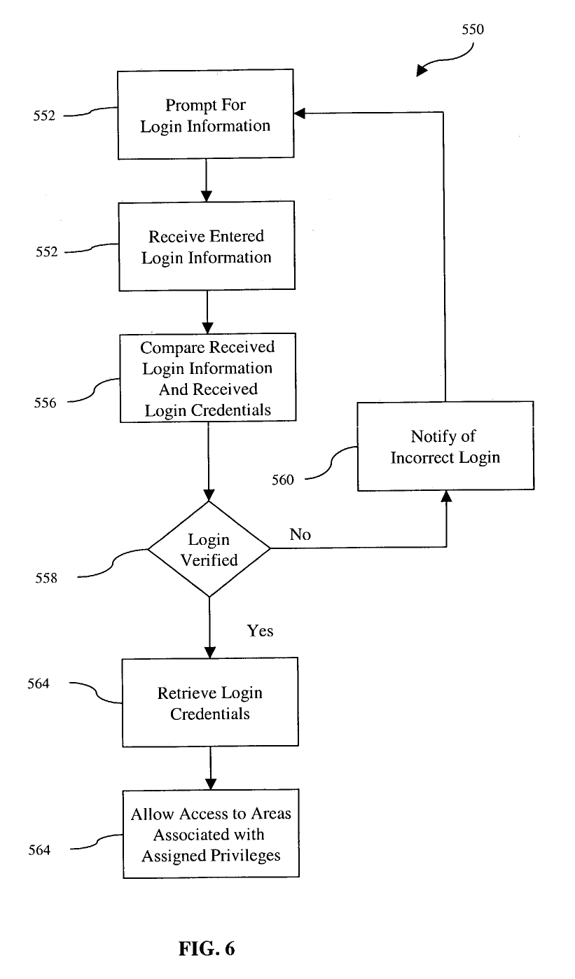

Referring to FIG. 6, an exemplary login procedure 550 of login component 402 of information management system 400 is shown. A user (LEA personnel) is prompted for login information, as represented by block 552. In one example, the user is prompted to input a user name or code and a password or personal identification number. In one variation, the user is prompted to enter login information into one or more fields in a data input form, which is at least a portion of a web page. Information management system 400 receives the entered login information, as represented by block 554. In one example, the login information is received over network 110. Information management system 400 compares the received login information to the information stored in user information database 530 to determine if valid login information has been received, as represented by block 556. In one example, information management system 400 generates a query to search user information database 530 for a user information record 531 that matches the received login information.

If the received login information does not match any of the user information records 531 in user information database 530, the user is notified of an incorrect login, as represented by blocks 558 and 560 and is prompted to reenter their login information. In one example, security measures are associated with the login procedure, such as a counter that tracks the number of incorrect login attempts for a given username or from a given computer or other data entry device, such as a cell phone or personal data assistant (PDA). Once a threshold number of incorrect login attempts occur, the user is not prompted to reenter their login information and the username is disabled. If the received login information matches a user information record 531 in user information database 530, the login credentials associated with that record are retrieved, as represented by block 564. In one example, the login credentials includes the access privilege associated with the user and the login credentials are stored as one or more fields in the user information record 531. The user having successfully logged into the information management system 400, is allowed access to areas associated with his/her login credentials, as represented by block 564.

Once the user has successfully logged into information management system 400, the user may create one or more new records in one or databases 120 that the user has access to based on the user's privileges, modify one or more existing records in one or more databases 120 that the user has access to based on the user's privileges, submit queries to one or more databases 120 that the user has access to based on the user's privileges, and/or view at least some of the information stored in at least one of the databases 120. It should be understood that members of community 130 including LEA personnel can submit queries to at least one of the databases 120 and view at least some of the information stored in at least one of the databases 120 without logging into the information management system 400. However, members of community 130 including LEA personnel cannot create records or modify records in the databases 120 without logging into information management system 400, with the exception of BOLO members database 528.

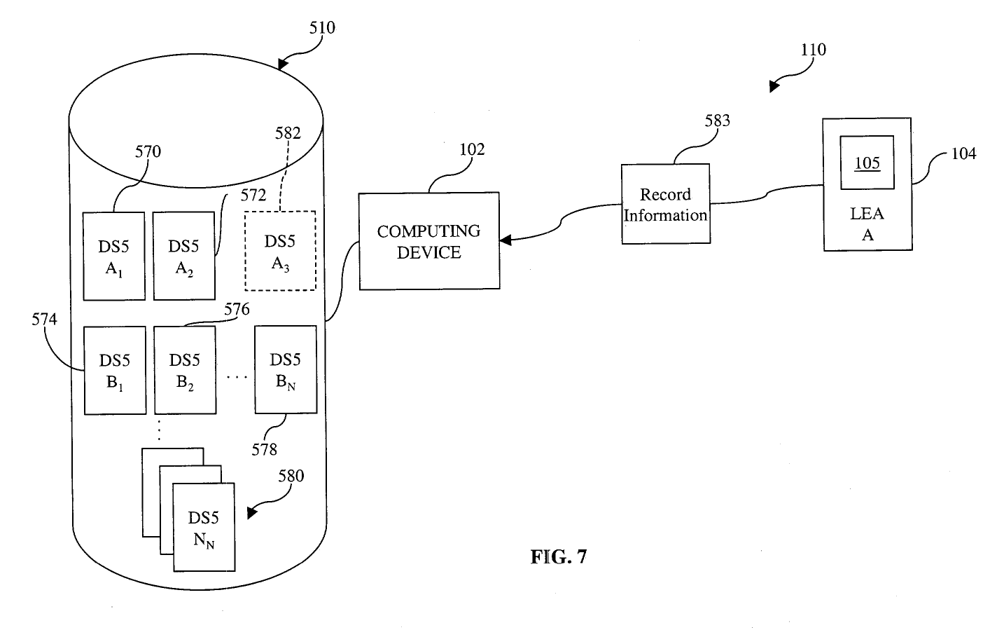

Referring to FIG. 7, missing children database (DS5) 510 is illustratively shown containing records DS5 A₁ 570 and DS5 A₂ 572 created by LEA A 104, a plurality of records including DS5 B₁ 574, DS5 B₂ 576, and DS5 B_{N} 578, from LEA B 106, and a plurality of records 580, including DS5 N_{N} from LEA N (not shown). It should be understood that information management system 400 is not limited by the number of records from a given LEA or by the number of LEAs. As shown in FIG. 7, record information 582 related to a new record DS5 A₃ 583 from LEA A 104 is being sent from computing device 105 of LEA 104 over network 110 to computing device 102. Record information 582 is used by information management system 400 to create new record 583 in database 510.

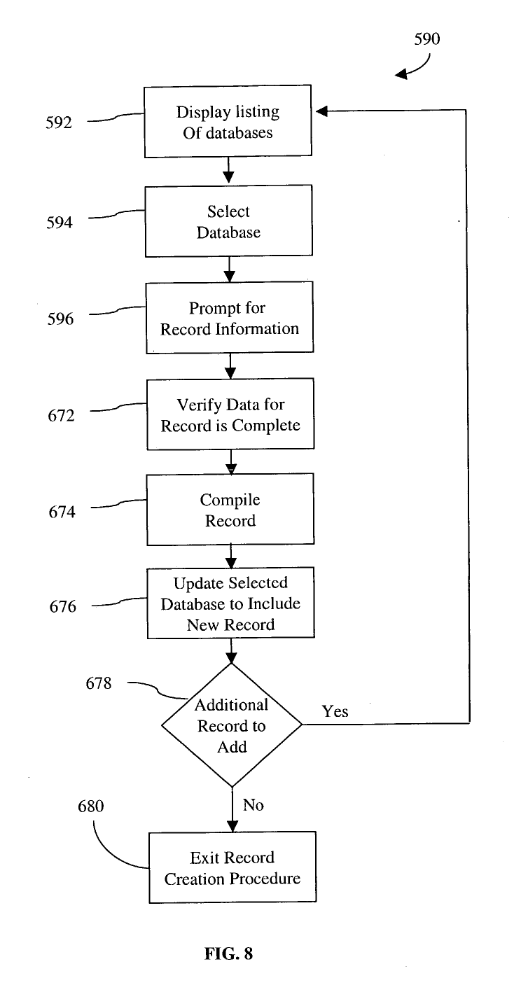

Referring to FIG. 8, a record creation procedure 590 of data input component 404 of information management system 400 for creating a new record, such as record DS5 A₃ 582, is shown. The user, assuming the user has the proper credentials based on login component 402, is presented with a listing of databases 120, as represented by block 592, from which the user selects a database, such as database 510, in which a new record is to be created, as represented by block 594. Once a database has been selected, the user is prompted for information for new record 582, as represented by block 596. In one example, the user is presented with a form, a series of questions, or other data entry tools designed to capture information related to record 582 from the user.

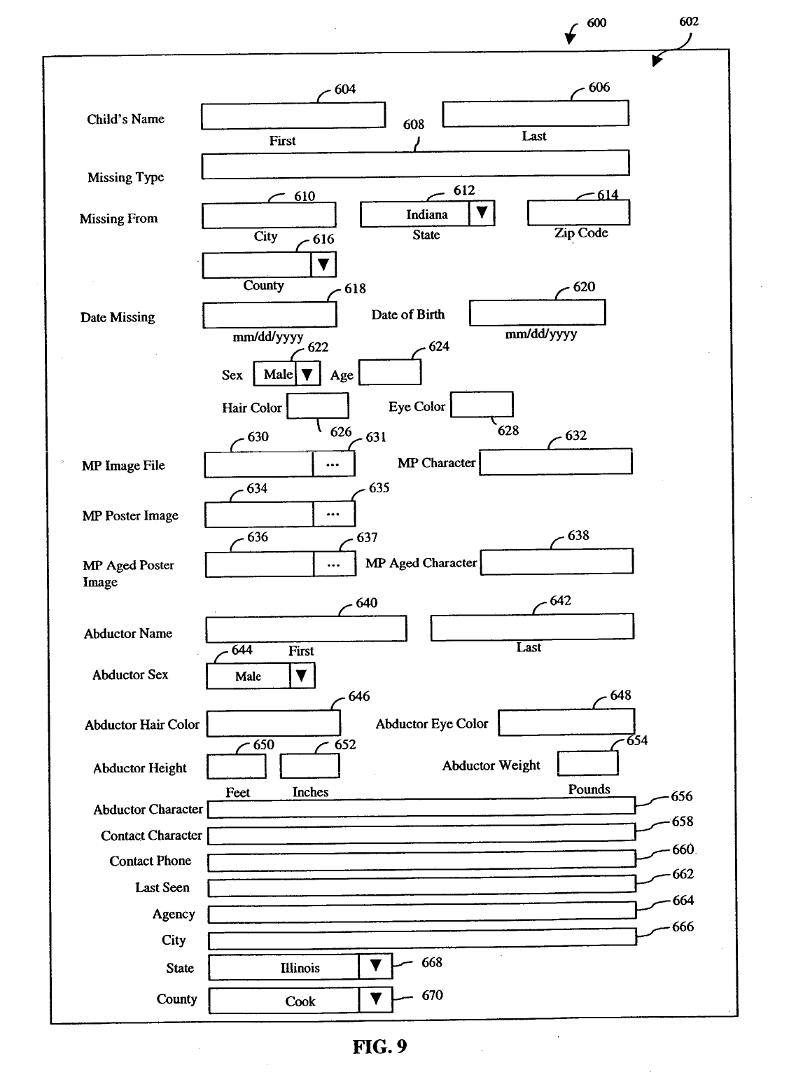

In a preferred embodiment, the user is presented with a web page 600 including a data input form 602, as shown in FIG. 9, to enter information related to new record 582. Form 602 provides a plurality of fields to be completed by the user. Some fields, such as fields 604 and 606, require the user to enter text. Other fields, such as fields 612, 616, 644, 668, 670 provide the user with a droplist to select an entry from a plurality of entries. Still other fields, such as fields 630, 634, 636 permit the user to enter a filename or browse for a file by selecting a browse icon 631, 635, 637 respectively. It is contemplated that form 602 may use any suitable type of data entry mechanism including text entry boxes, date entry boxes, number entry boxes, droplists, buttons, and check boxes. It should be noted that a form, similar to form 602, may be created to populate a record 503, 505, 507, 509, 511,513, 515, 517, 519, 521, 523, 525, 527, 529, and 531 of any of databases 502, 504, 506, 508, 510,512, 514, 516, 518, 520, 522, 524, 526, 528, and 530.

The fields shown in form 602 correspond to the fields listed in Table 5 for exemplary missing child record 511. Fields 604, 606, 608, 610, 612, 614, 616, 618, 620, 622, 624, 626, 628, 630, 632, 634, 636, 638, 640, 642, 644, 646, 648, 650, 652, 654, 656, 658, 660, 662, 664, 666, 668, 670 correspond to field names “Childs Name—First”, “Childs Name—Last”, “Missing Type”, “Missing From—City”, “Missing From—State”, “Missing From—Zip”, “County”, “Date Missing”, “Date of Birth”, “Sex”, “Age”, “Hair Color”, “Eye Color”, “MP Image File”, “Missing Person Character”, “MP Poster Image”, “MP Aged Poster Image”, “MP Aged Image Character”, “Abductor First Name”, “Abductor Last Name”, “Abductor Sex”, “Abductor Hair Color”, “Abductor Eye Color”, “Abductor Date of Birth”, “Abductor Height Feet”, “Abductor Height Inches”, “Abductor Weight”, “Abductor Character”, “Contact Character”, “Contact Phone”, “Last Seen”, “Agency”, “City”, “State”, and “County”, respectively, It should be understood that some of the fields are redundant. For example, the value for Age, field 624, may be calculated from the date of birth, field 620, and knowledge of the current date by computing device 102. In one example, form 602 does not include field 624 and the value for “Age” in record 582 is determined from field 620 and knowledge of the current date. In another example, form 602 includes both fields 620 and 624 and compares the entered values as an error checking mechanism.

Returning to FIG. 8, once the user has been prompted for the record information, as represented by block 596, information management system 400 checks to verify that the record information entered into form 602 is complete, as represented by block 672. In one example, wherein all fields 604, 606, 608, 610, 612, 614, 616, 618, 620, 622, 624, 626, 628, 630, 632, 634, 636, 638, 640, 642, 644, 646, 648, 650, 652, 654, 656, 658, 660, 662, 664, 666, 668, 670 are required to have a value, system 400 checks to make sure all of the fields 604, 606, 608, 610, 612, 614, 616, 618, 620, 622, 624, 626, 628, 630, 632, 634, 636, 638, 640, 642, 644, 646, 648, 650, 652, 654, 656, 658, 660, 662, 664, 666, 668, 670 includes a value that corresponds to the respective field type. If a field is blank or does not have information in the correct format, the system will prompt the user to enter or reenter the missing or incorrect information. In another example, not all of the fields 604, 606, 608, 610, 612, 614, 616, 618, 620, 622, 624, 626, 628, 630, 632, 634, 636, 638, 640, 642, 644, 646, 648, 650, 652, 654, 656, 658, 660, 662, 664, 666, 668, 670 require a value for form 602 to be complete. For instance, it is possible that an aged poster picture might not be available such that at least field 636 cannot be completed or that the identity of the abductor is unknown such that fields 640, 642, 644, 646, 648, 650, 652, 654, 656 cannot be completed. In such a case, system 400 verifies that the fields containing information include values corresponding to the respective field type and that the fields of fields 604, 606, 608, 610, 612, 614, 616, 618, 620, 622, 624, 626, 628, 630, 632, 634, 636, 638, 640, 642, 644, 646, 648, 650, 652, 654, 656, 658, 660, 662, 664, 666, 668, 670 which are required contain information.

Once it is verified that the record information is complete, system 400 compiles record 582, as represented by block 674 and updates database 510 to include record 582, as represented by block 676. At this point record 582 is available for searching or viewing by members of community 130 or LEA personnel at LEA 104, 106, 108. Further, as explained in more detail below, system 400 may be configured to generate a BOLO alert record 527 in the BOLO alert database 526 to selected BOLO members from the BOLO member database 528 at this point. As such, once record 582 has been added to database 510, the information is available to generate alerts or to be retrieved by a variety of users. Now that record 582 has been added to database 510, the LEA personnel who entered the information related to record 528 may choose to create an additional record, as represented by block 678 or may exit record creation procedure 590, as represented by block 680.

Information management system 400 allows a user, assuming the user is logged into information management system 400 and has the proper credentials, to modify existing database records. In one example, a user may only modify records created by that user. In this example, each record is tagged with information to associate that record to the creator of the record. In another example, a user may only modify records associated with the LEA 104, 106, 108 or group of LEAs that the user is associated therewith. In this example, each record is tagged with information to associate that record to the LEA the creator of record is associated therewith. In yet another example, a user may modify any record in a given database, regardless of the creator of the record. In still a further example, when a user modifies a record the date and/or time along with information identifying the user is associated with the modified record so that at a later time it can be determined by whom and when a given record was modified.

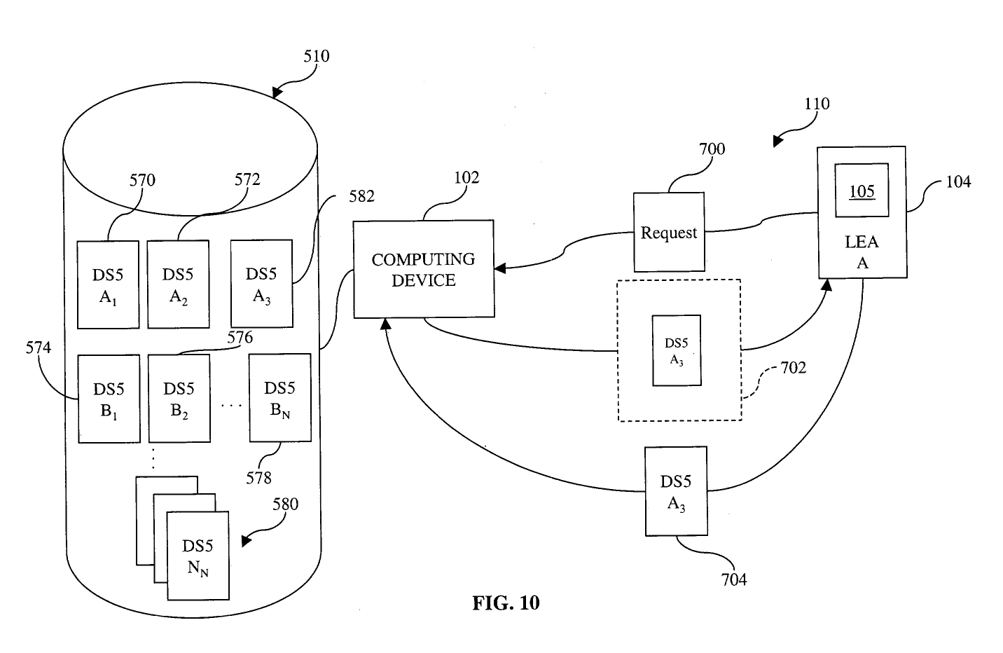

The process of modifying a record is illustratively shown in FIG. 10. Referring to FIG. 10, a user at LEA A 104, who is logged on to information management system 400 and has proper credentials, initiates a request 700 for the information contained in record DS5 A₃ 582 over network 110. Information management system 400 based on request 700 retrieves record information related to record DS5 A₃ 582 from database 510 and sends record information 702 to the user at LEA A 104 whom requested it. Record information 702 is presented to the user for review. In a preferred embodiment, record information 702 is presented to the user in a form similar to form 602 of FIG. 9. The user reviews record information 702, makes any necessary modifications, including additions, and sends updated record information 704 to database 510. Record 582 is then updated with record information 704.

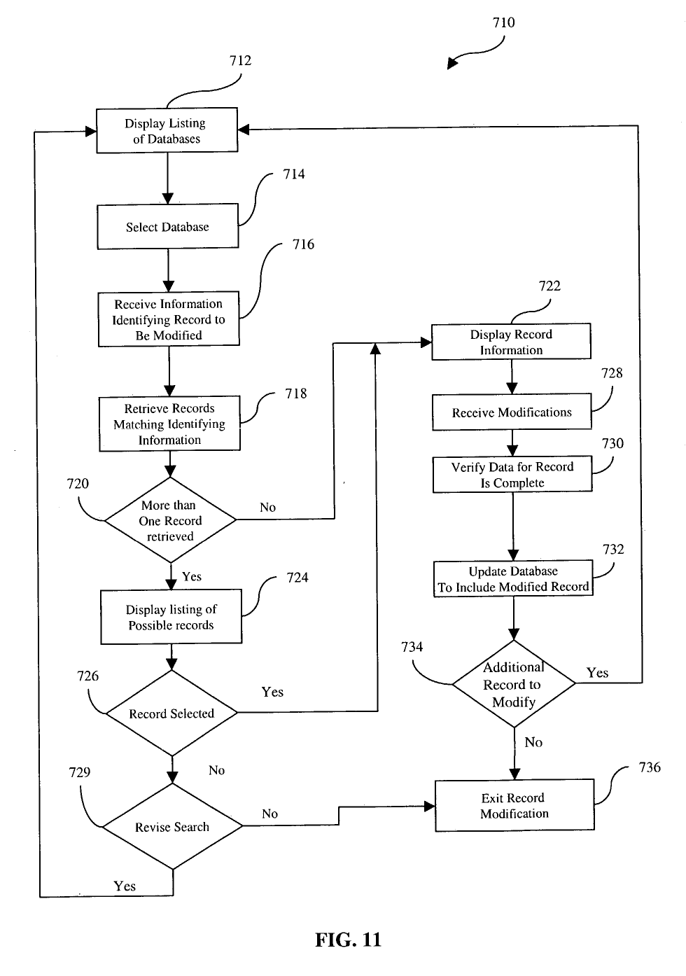

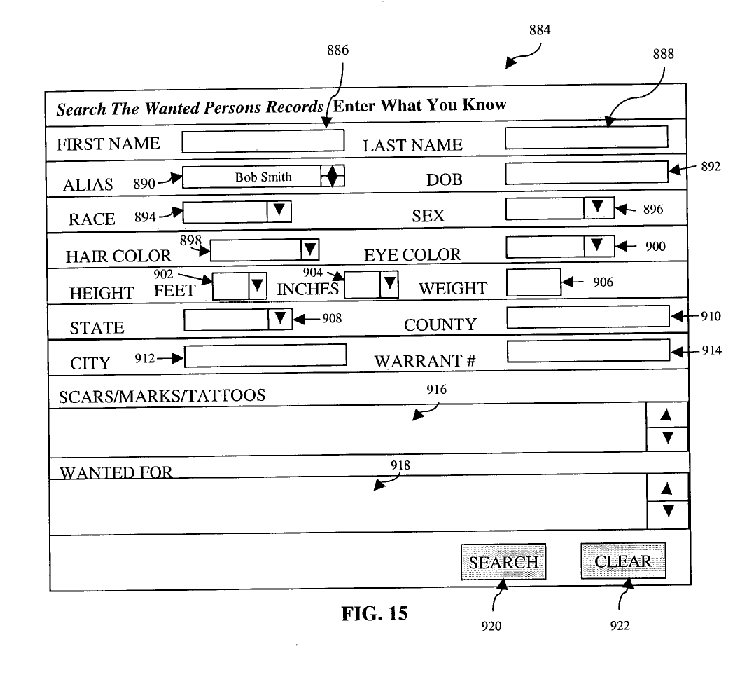

A record modification procedure 710 of information management system 400 for modifying the information contained in an existing record is shown in FIG. 11. The user, assuming the user has the proper credentials, is presented with a listing of the databases 120, as represented by block 712, from which the user selects database 510 containing record 582 to be modified, as represented by block 714. Once database 510 has been selected, the user is prompted for information for about record 582 to be modified, as represented by block 716. In one example, the user is presented with a query form similar to query form 884 discussed below in connection with FIG. 15. In an alternate embodiment, all the records in the selected database that may be modified by the user are listed.

Information management system 400 retrieves identifying information related to all records that match the record information provided by the user, as represented in block 718. If only a single record matches the record information provided by the user to identify the record in request 700, then record information 702 is presented to the user, as represented by blocks 720 and 722. In a preferred embodiment, record information 702 is presented in a form similar to form 602 shown in FIG. 9. If multiple records match the record information provided by the user in request 700, the user is presented with a listing of the matching records, as represented by blocks 720 and 724. In a preferred example, the user is presented a listing having the first name and last name of the missing child and a hyper link or other mechanism for selecting a given record. The user selects the appropriate record, as represented by block 726 and record information 702 is presented to the user, as represented by block 722. However, if the desired record is not in the list, the user has the option to revise the search as represented by block 729.

The user makes all the necessary modifications to record information 702 and sends modified record information 704 to computing device 102, as represented by block 728. Information management system 400 verifies that record information 704 is complete, as represented by block 730. If record information 704 is complete, record 582 is updated to include information 704 as represented by block 732. At this point the record is available for searching or viewing by members of community 130 or LEA personnel at LEA 104, 106, 108. Further, as explained in more detail below, system 400 may be configured to generate a BOLO alert record 527 in the BOLO alert database 526 to selected BOLO members from the BOLO member database 528 at this point. Now that the record 582 has been modified with record information 704, the LEA personnel may choose to modify an additional record, as represented by block 734 or may exit record modification procedure 590, as represented by block 736.

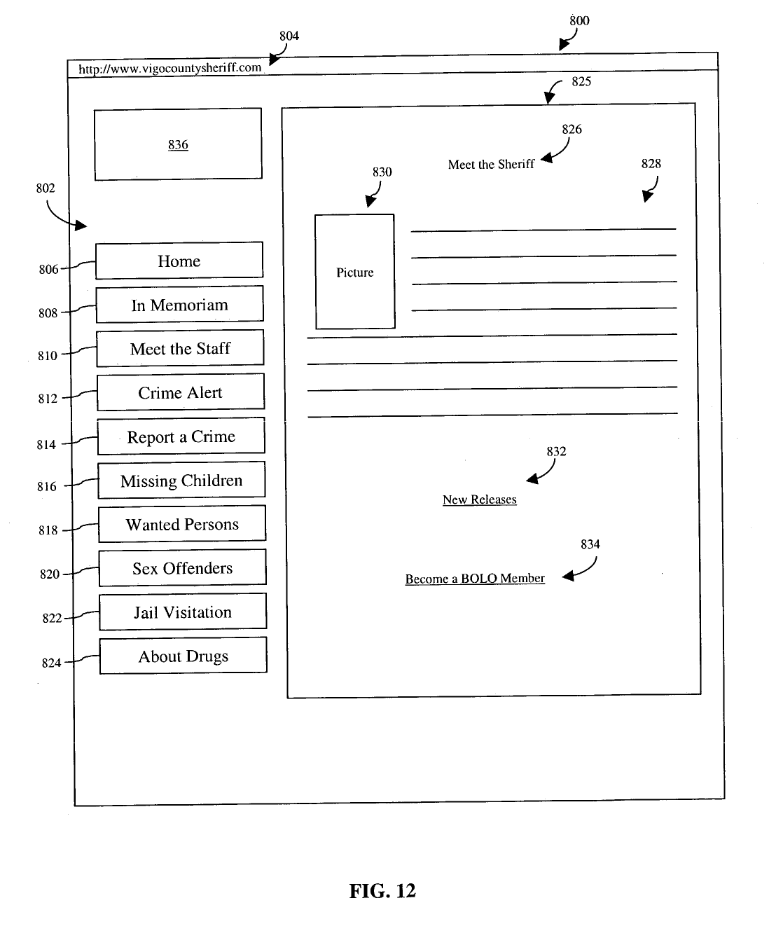

Turning to FIG. 12, an exemplary web browser 800 containing a web page 802 whose content is managed by information management system 400 is shown. Web page 802 is illustratively shown to be the “Meet the Sheriff” home page of the Vigo County Sheriff's Department. Page 802 corresponds to the “home” record of Table 12 which is the exemplary web page information record. Web page 802 has an address 804 associated therewith that would be listed in the field type for the record “home”. Page 802 further includes links to other pages 806, 808, 810, 812, 814, 816, 818, 820, 822, 824 and the specific content of the home page, such as a title 826, text 828, a picture 830, links to additional pages 832 and 834. Pages 806, 808, 810, 812, 814, 816, 818, 820, 822, 824, 832, 834 are in one example generated by information management system 400.

Page 802 additional includes a location 836 for advertisements. In a preferred embodiment, the number of advertisers whose ads appear in location 836 is between one and five. In one example, the number of advertisers is up to four. The number of advertisers is sufficiently small such that the advertisements associated with the advertisers are shown often to visitors to the site. By increasing the frequency and/or duration that ads may be displayed on page 802 and associated pages, the advertisers associated with those advertisements increase the exposure they have to persons in the community interested in law enforcement. Some advertisers will pay a premium to have their advertisements shown more often to visitors to the site. As such, it has been found that by limiting the number of advertisers to about four, the fees associated with advertising can be raised to a level that at least the cost associated with information management system 400 is covered by the advertising fee revenue.

In one embodiment, the advertisements and/or associated advertisers are different for a front end of information systems 100, 100′ and 200 and for a back end of information systems 100, 100′ and 200. The front end of information systems 100, 100′ and 200 is defined as portions of information systems 100, 100′ and 200 that are accessible by community 130 either alone or along with LEA 104, 106, 108. The back end of information systems 100, 100′ and 200 is defined as the portions of information systems 100, 100′ and 200 that are only accessible by LEA 104, 106, 108, not the community 130. Example back end components are the data entry capability of the various records such as crime alert, missing persons, and other web pages, as well as the criminal profiling and other interdepartmental features of information systems 100, 100′ and 200. As such, different advertising space may be allotted to different audiences. For example, front end advertisers might include banks, car dealers, bail bondsmen and back end advertisers might include law enforcement accessory companies, firearm companies, insurance carriers. In another example, front end advertisers might be local businesses to the respective agencies while back end advertisers might be national businesses that have appeal to all of the respective agencies (the front end is typically viewed by community members and LEA personnel of the local agency while the back end may be viewed by multiple agencies in various locations). Therefore advertisers may target their audiences.

It is contemplated to limit both the number of front end advertisers and the number of back end advertisers. In one example, at least one of front end advertiser and back end advertisers is limited to between one and five. In another example, the number of at least one of front end advertisers and back end advertisers is limited to up to four. In yet another example, the number of at least one of front end advertisers and back end advertisers is limited to up to two. In another example, the number of at least one of front end advertisers and back end advertisers is limited to one. The number of advertisers for at least one front end advertisers and back end advertiser is sufficiently small such that the advertisements associated with the advertisers are shown often to visitors to the site. Some advertisers will pay a premium to have their advertisements shown more often to visitors to the site. As such, it has been found that by limiting the number of advertisers, such as front end advertisers and/or back end advertisers, such as up to about four, the fees associated with advertising can be raised to a level that at least the cost associated with information management system 400 is covered by the advertising fee revenue.

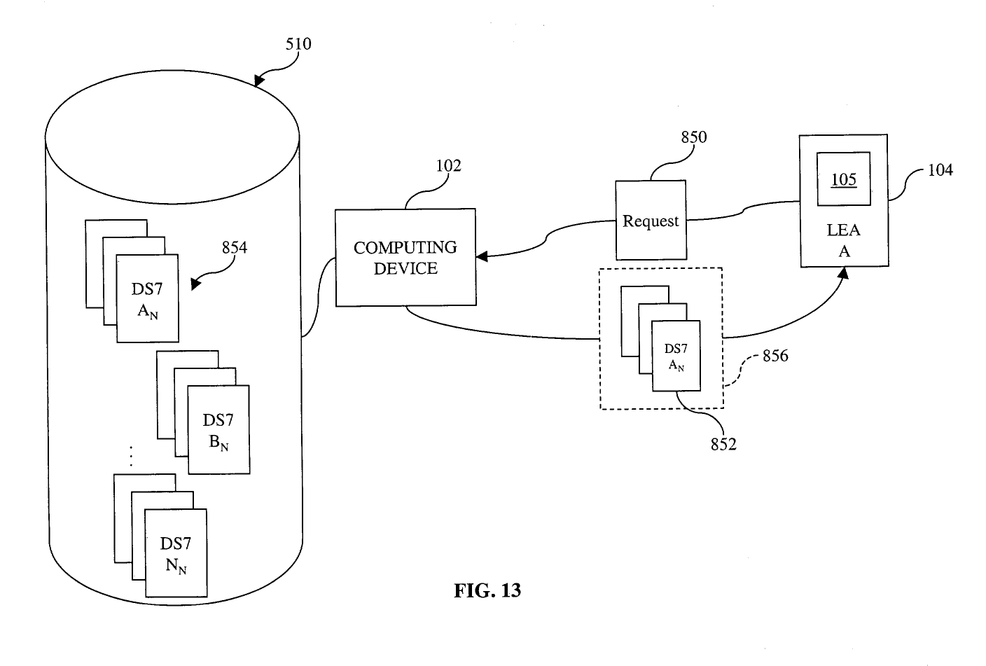

Returning to FIG. 12, a member of community 130 interested in persons in Vigo County that have outstanding warrants can determine this information by selecting link 818 “Wanted Persons”. By selecting link 818 the member of community 130 is initiating a request 850 to information management system 400, as shown in FIG. 13. Request 850 is configured to prompt the data searching component 404 of information management system 400 to determine all database records in the wanted persons database 514 associated with LEA A 104, which in this example is the Vigo County Sheriff's Department. As such, information management system 400 determines record database records DS7 A₁-DS7 A_{N} 854 are associated with LEA A104. Information management system 400 provides the community member 130 with record information 852 related to database records 854.

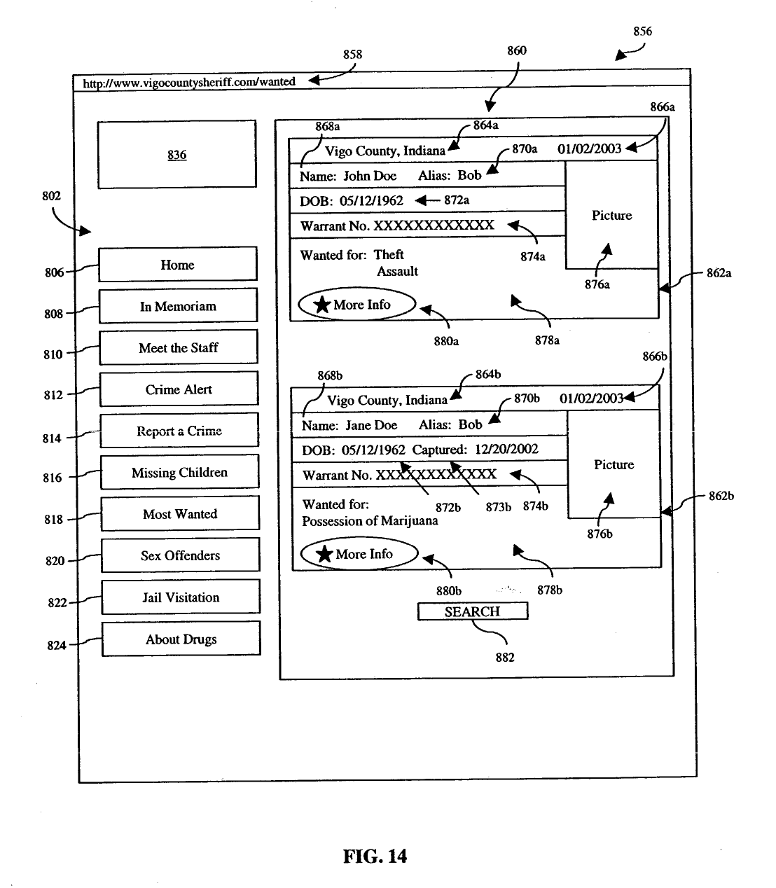

In a preferred embodiment, at least a portion of the information contained in record information 852 is presented to the member of community 130 who requested the information as web page 856, shown in FIG. 14. In one example, information management system 400 generates wanted persons web page 856 (see FIG. 14) at computing device 102 and transmits wanted persons web page 856 to the community member 130. For example, the provided information in request 850 and record information 852 is used to generate web page 856 by any suitable method, including ASP and CGI. In an alternative embodiment, information management system 400 includes a program resident on computing device 105 of LEA A 104 that receives record information 852 from computing device 102 and generates wanted persons web page 856 from the received record information 852.

Web page 856 includes an address 858 and is generally similar to web page 802, shown in FIG. 12. Web page 856 includes location 836 configured to present the community member 130 with advertisements, links to other pages 806, 808, 810, 812, 814, 816, 818, 820, 822, 824 and a content frame 860 including content specific to the wanted persons page 856.

The content specific to wanted persons page 856 includes wanted persons information boxes 862a, 862b which are configured to present the member of community 130 with at least a portion of record information 852. Although only two wanted persons information boxes 862a, 862b are shown, it should be understood that in a preferred embodiment each record corresponding to request 850 has an associated wanted persons information box 862. If all of the associated information boxes 862 are not viewable in content window 860 at the same time, content window 860, in one example, includes a scroll bar (not shown), or in another example, content window 860 is divided into multiple content windows (not shown) accessible by links (not shown).

Wanted persons information boxes 862a, 862b include exemplary information retrieved from the respective records 854. Wanted persons information boxes 862a, 862b illustratively include the locality the person has an outstanding warrant in 864, the date the warrant was issued 866, the name of the person 868, known aliases of the person 870, the date of birth of the person 872, the warrant number 874, a picture of the person 876, a description of the charges 878, and a link 880 to a second wanted person information box (not shown) which includes further and/or more detailed information.

In one example the respective records 854 include the exemplary fields presented in Table 7. As such, the locality the person has an outstanding warrant in 864 corresponds generally to the fields named “STATE” and “COUNTY”. The date the warrant was issued 866 corresponds generally to the field named “Disposition Date”. The name of the person 868 corresponds generally to the fields named “FIRST NAME” and “LAST NAME”. The known aliases of the person 870 correspond generally to the field named “ALIAS”. The date of birth of the person 872 corresponds generally to the field named “DOB”. The warrant number 874 corresponds generally to the field named “WARRANT NUMBER”. The picture of the person 876 corresponds generally to the field named “wanted_thumbnail”, “no image available”, “LARGE IMAGE”, or “Not_in_use_Icon_Image”. The description of the charges 878 corresponds generally to the field named “WANTED FOR”.

Web page 856 further includes a search link 882 which allows the member of community 130 to search the records in database 514 with a custom query. Selecting search link 882 presents the user with a query form, such as exemplary query form 884 shown in FIG. 15. In one example, query form 884 replaces search link 882 on page 856.

Query form 884 allows a user, such as members of community 130 and personnel at LEA 104, 106, 108, to search the records in database 514 for records that satisfy the criteria supplied by the user to query form 884. All records in database 514 that satisfy the criteria supplied by the user are presented in a web page (not shown), generally similar to web page 856.

Referring to FIG. 15, query form 884 includes one or more fields that the user may populate to define the query criteria. For example, the user may specify information related to the first name of the wanted person in field 886, information related to the last name of the wanted person in field 888, information related to one or more known aliases of the wanted person in field 890, information related to the date of birth of the wanted person in field 892, information related to the race of the wanted person in field 894, information related to the sex of the wanted person in field 896, information related to the hair color of the wanted person in field 898, information related to the eye color of the wanted person in field 900, information related to the height of the wanted person in fields 902 and 904, information related to the weight of the wanted person in field 906, information related to the locality issuing the warrant for the arrest of the wanted person in fields 908, 910, 912, information related to the warrant number associated with the wanted person in field 914, information related to distinguishing characteristics of the wanted person, such as scars, marks, tattoos, in field 916, and information related to the type of crimes the wanted person is accused of in fields 918.

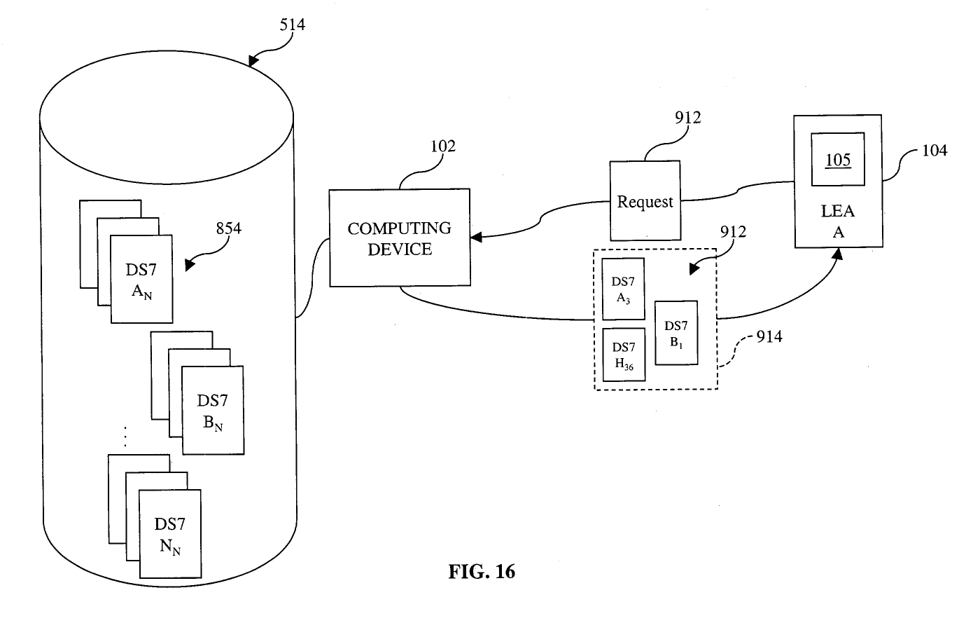

The user does not need to complete all of the fields 886, 888, 890, 892, 894, 896, 898, 900, 902, 904, 906, 908 of search form 884. Whatever information provided by the user in fields 886, 888, 890, 892, 894, 896, 898, 900, 902, 904, 906, 908 is used as the criteria by information management system 400 to determine which records from database 514 satisfy the query. Once the user has completed the desired fields 886, 888, 890, 892, 894, 896, 898, 900, 902, 904, 906, 908 of query form 884, the user selects a button 920, labeled “Search”, to initiate a request 912 (see FIG. 16) for information management system 400 to perform a search of database 514 with the criteria entered into one or more of fields 886, 888, 890, 892, 894, 896, 898, 900, 902, 904, 906, 908 of query form 884. A button 922, labeled “Clear” is also provided and is configured to delete any information previously entered in one or more of fields 886, 888, 890, 892, 894, 896, 898, 900, 902, 904, 906, 908.

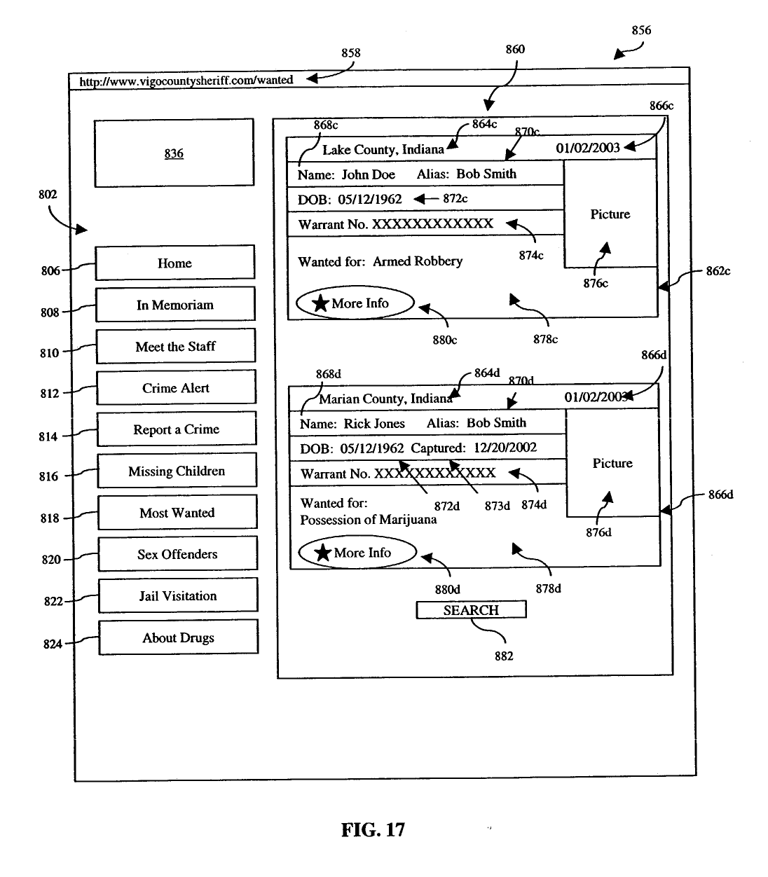

Turning to FIG. 16, the user submits request 912 to information management system 400. Data searching component 404 of information management system 400 recognizes that request 912 corresponds to database 514 and generates a query to search database 514 to determine if one or more records of database 514 satisfy the criteria supplied in request 912. Data searching component 404 of information management system 400 generates a web page 914 (similar to the one shown in FIG. 17), generally similar to web page 856 of FIG. 14, based at least on the information 916 contained in the records of database 514 that satisfy the supplied criteria of request 912.

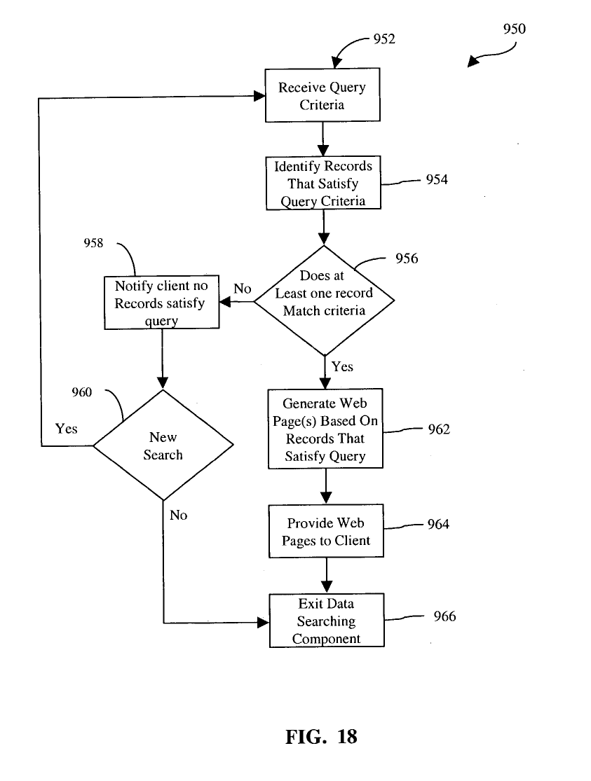

Referring to FIG. 18, an exemplary flowchart of a custom query procedure 950 of data searching component 494 is shown. Information management system 400 receives the query criteria across the network, as represented by block 952. A query of the appropriate databases, such as database 514, is made by data searching component 406 with a query formulated from the received query criteria to identify records that satisfy the query criteria, as represented by block 954. In an alternate example, the query is received across the network and not formulated by information management system 400. If no records satisfy the received query criteria, the user who submitted the query is notified that no records satisfy the received query, as represented by blocks 956 and 958. Data searching component 406 inquires whether another search should be conducted, as represented by block 960.

If at least one record satisfies the received query criteria, data searching component 406 provides information related to the at least one record which satisfies the query criteria to the user. In one example, the information related to the at least one record which satisfies the query criteria is provided as a web page which is generated by data searching component 406, as represented by blocks 962 and 964. After the web page has been generated and transmitted, information management system 400 exits the custom query procedure 950, as represented by block 966.

Turning back to FIG. 15, the query search form 884 contains only one entry, the name “Bob Smith” in the Alias field, field 890. Once the Search button 920 has been selected, the query criteria, all records which have the name “Bob Smith” in the Alias field, is sent to information management system 400 which, in one example, executes the exemplary procedure shown in FIG. 18. The result of the search by information management system 400 is the generated and transmission of a web page 856, as shown in FIG. 17 to the computing device of the user, such as computing device 131.

As shown in FIG. 17, two records satisfy the submitted query criteria. The record shown in wanted person information box 862c is wanted in Lake County, 864c, on the charge of armed robbery, 878c. The record shown in wanted person information box 862d is wanted in Vigo County, 864d, on the charge of Possession of Marijuana, 878d. As such, information system 100 is able to provide updated information from multiple jurisdictions from a simple query submission.

In one embodiment, information management system 400 is able to formulate intelligent queries that are more robust than simply searching for the terms supplied to query form 884. In one example, information management system 400 includes in the formulated query synonyms or related items. For instance, if a user requests all wanted persons having a tattoo of a snake on their left forearm, information management system 400 formulates a query that looks for records in database 514 that have either a snake, a cobra, or a reptile tattoo instead of simply records in database 514 that have a snake tattoo. In another example, information management system 400 expands the names provided in the query form 884. For instance, if the user submits a query for a wanted person named John Doe, information management system 400 formulates a query which looks for records in database 514 that have a last name “Doe” and a first name of either “John”, “Johnny”, “Jonathan”, “Jack”, or “Johnnie”.

In yet another example, information management system 400, allows a user to submit Boolean operators, such as AND, OR, NOT, between fields and wildcard designations. For example, a user can search for wanted persons records in database 514 for persons having the name components “John AND Doe”, requiring that the satisfying record have both terms, or the name component “John OR Doe”, requiring that the satisfying record have at least one of the terms. A user can also submit a query for wanted persons that have a last name beginning with the string “Ma” by including a wildcard designator. As such, database system 400 will return all records in database 514 that have a last name beginning with the string “Ma”, such as “Madison” or “Mayberry”.

In still a further example, information management system 400 correlates known relations between information to expand a search. For instance, assume a user submits a query for all wanted persons that are known to use a given slang phrase by including the slang phrase in a slang field (not shown) of query form 884. Information management system 400 recognizes that the received slang phrase is sometimes correlated to members of a given gang. As such, information management system 400 can formulate a query of database 514 to search for records having the specified slang phrase, a known tattoo associated with the gang, or other information. In one example, information management system 400 provides a relevance indicator for each record provided to the user as a result of the search.

In another embodiment, information management system 400 accepts image files which are used as search criteria to search associated image files of a given database. It is well known in the art to correlate image files using known image processing techniques. For instance, a user may obtain an image of a person and submit that image to information management system 400 to determine if that person or someone who looks similar has an outstanding warrant (database 514). In one case, an officer submits an image of a suspect being detained at the station or in the field, such as at a traffic stop, to information management system 400. In another case, a user takes an image of a person with a portable computing device, such as a Sprint PCS cell phone available from Sprint PCS Wireless located at on the Internet at http://www.sprintpcs.com and submits the image to information management system 400. In still a further case, security cameras, routinely submit images of persons within the field of view of the camera to information management system 400. In one example, information management system 400 is configured to disregard certain easily changeable features, such as hair color, facial hair, and others when searching for records that satisfy a query including a given image file. In one example, information management system 400 provides a relevance indicator for each record provided to the user as a result of the search.

In another embodiment, information management system 400 accepts a marker as a search criteria. It is well known in the art to correlate markers with known markers. Example markers include fingerprint images, fingerprint key points, a retina image, retina key points, a DNA listing, DNA key points, and other suitable identification markers. Information management system 400 searches for records that satisfy the submitted marker characteristics or that are close to the submitted marker characteristics. For instance, it is known to characterize fingerprint matches based on the number of key points that can be correlated. In one example, information management system 400 provides a relevance indicator for each record provided to the user as a result of the search.

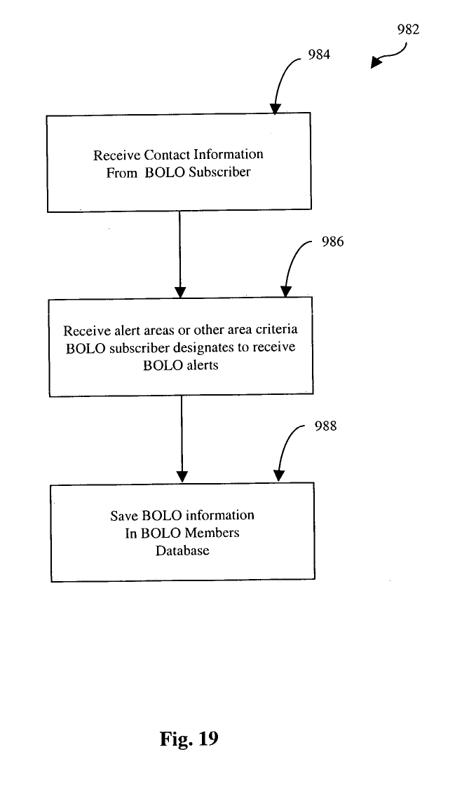

As generally discussed above one of the features of information system 100, 200 is the ability to issue alerts, such as BOLO alerts, to members of the community that have supplied contact information. Turning to FIG. 19, a flowchart of an exemplary alert subscription procedure 982 of alert component 407 of information management system 400 is shown.

The information management system 400 receives contact information from the member of the community requesting to be a BOLO subscriber, as represented by block 984. The BOLO contact information includes at least one address that the subscriber desires to receive all alerts at. Exemplary addresses include an e-mail address, a pager number, a phone number, a fax number, a postal address, and a network address. In one example, BOLO contact information further includes locality information such as a home address, a work address, a home region, such as a county, or a work region, such as a county. The locality information may be used by law enforcement agencies 104, 106, 108 in determining what subscribers to sent an alert to based on a crime or event happening in a given geographical area, as explained in more detail below.

In another example, the computing device associated with the member of the community is a portable device, such as a cell phone and the computing device has the capability of providing location information, such as a location determined by known GPS methods. Further, the portable computing device is configured to modify the locality information associated with the BOLO member based on the location information of the portable computing device. In one example, the portable computing device provides its location information at a given interval. As such, the associated BOLO member can receive BOLO alerts as the BOLO member and the computing device travel from area to area.

Information management system 400 also receives alert area or other alert criteria the BOLO member wishes to receive alerts related to, as represented by block 986. An alert area includes a jurisdiction of a law enforcement agency, such as a county, municipality, or state, or a other areas, such as a metropolitan area or an area defined by a distance from a given point, such as a home, office, or current location. Other alert criteria includes types of alerts or events, such as missing children, unsolved crimes, fugitive announcements, specific crimes such as robbery, or other suitable criteria. In one example, the alert criteria is selected from one of geographical criteria, temporal criteria, and event criteria.

Once the BOLO contact information and/or alert areas or criteria has been received, information management system 400 updates the BOLO members database 528 to include the new BOLO member, as represented by block 988.

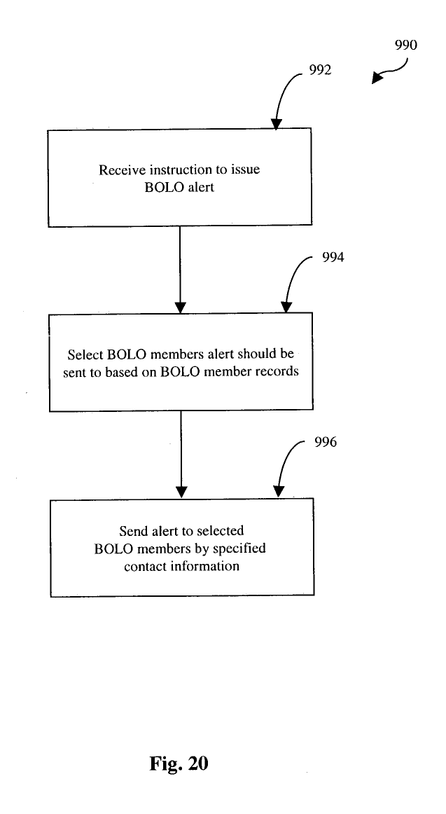

Referring to FIG. 20, an alert generation procedure 990 of alert component 407 is shown. Information management system 400 receives instructions from an LEA 104, 106, 108 across network 110 to issue a BOLO alert, as represented by block 992. In one example, the LEA 104, 106, 108 must expressly specify each time a BOLO alert is to be sent. In one method, the law enforcement agency 104, 106, 108 simply manually creates a new record in the BOLO alert database 526. In another example, the information management system 400 is configured by LEA 104, 106, 108 to automatically creates a new record in the BOLO alert database 526. In yet a further example, a given LEA configures information management system 400 to automatically send some BOLO alerts and to require manual submission of other BOLO alerts. For example, a given LEA may wish that every new missing child record 511 automatically generate a BOLO alert and wish that an unsolved crimes record 521 only be sent as a BOLO alert when a decision has been made to seek assistance from the community with an unsolved crime.

Once instructions have been received to issue a BOLO alert, information management system 400 further determines which BOLO subscribers should receive the alert based on the information stored in the BOLO members records, as represented by block 994. Once the BOLO subscribers have been determined, the alert is sent to the BOLO members at their specified contact information, as represented by block 996.

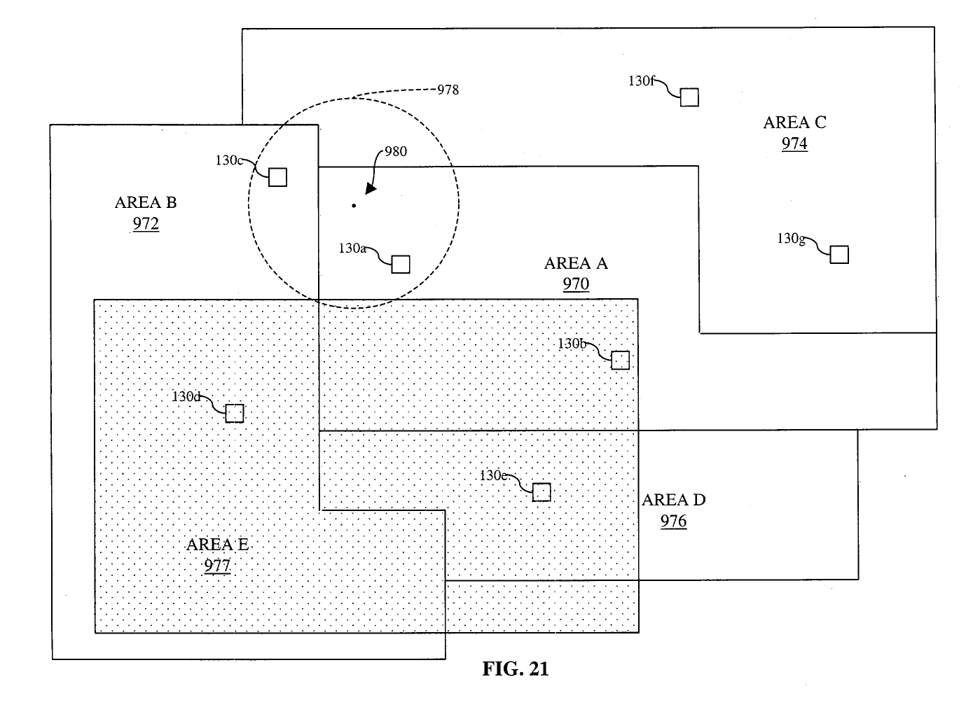

Referring to FIG. 21, an example region is shown having an AREA A 970, AREA B 972, AREA C 974, AREA D 976, and AREA E 977. AREA E 977 overlaps portions of AREAS A, B, D 970, 972, 976. In one example, AREAS 970, 972, 974, 976, 977 correspond to respective law enforcement agencies. As such, AREA E 977 might be a city police force and AREAS A, B, D 970, 972, 976 might be county sheriff departments.

AREA A 970 includes two community members 130a, 130b which have subscribed to the BOLO alert system. AREA B 972 includes two community members 130c, 130d which have subscribed to the BOLO alert system. AREA C 974 includes two community members 130f, 130g which have subscribed to the BOLO alert system. AREA D 976 includes one community member 130e which has subscribed to the BOLO alert system. AREA E 977 includes three community members 130b, 130d. 130e which have subscribed to the BOLO alert system.

In one example, each community member 130a, 130b, 130c, 130d, 130e, 130f, 130g has subscribed to receive BOLO alerts from their respective AREAS 970, 972, 974, 976, 977. Further, community member 130a has subscribed to receive BOLO alerts from AREAS 974 and 977. Additionally, community member 130g has subscribed to receive BOLO alerts for all missing children alerts from AREAS 970, 972, 974, 976, 977.

Therefore, in one case an alert issued by the law enforcement agency associated with AREA D 976 for an unsolved crime will be received by community member 130e alone. However, in another case an alert issued by the law enforcement agency associated with AREA D 976 for a missing child will be received by community member 130e and community member 130g, because community member 130g has requested to receive all missing children alerts from AREAS 970, 972, 974, 976, 977. In still another case, an alert issued by the law-enforcement agency associated with AREA E 976 for a missing person will be received by community members 130b, 130d, 130ebecause each is within AREA E 977 and by community member 130a because community member 130a requested to receive all alerts from AREA E.

As stated above, a law enforcement agency is not bound to send alerts only to the community members of community members 130a, 130b, 130c, 130d, 130e, 130f, 130g which have subscribed to a particular alert. On the contrary, a law enforcement agency may set its own alert criteria for the recipients of a BOLO alert. In one example, the alert criteria is selected from one of geographical criteria, temporal criteria, and event criteria. For instance, the law enforcement associated with AREA E 977 may decide to send an alert for a wanted person to those community members in AREA C 974. As such, community members 130f, 130g will receive the alert because they are both in AREA C 974, community members 130b, 130d, 130e will receive the alert because they have requested to receive all alerts from AREA E 977 (note it would be different if they had requested all alerts issued for AREA E), and community member 130a because community member 130a requested to receive all alerts for AREA C 974.

However, in one example, the criteria set by the law enforcement agency is subservient to the BOLO criteria specified by a community member. For instance, the law enforcement agency associated with AREA A 970 may issue an alert for a missing child for all BOLO subscribers, community members, within a given zone 978 of the abduction location 980. As such, the BOLO alert will be sent to community members 130a and 130c because they are within the zone 978. Further, the BOLO alert will be sent to community member 130b because community member 130b requested to receive all alerts from AREA A and community member 130g because community member 130g requested to receive all BOLO alerts related to missing children.

In another example, the criteria set by the law enforcement agency is dominant to the BOLO criteria specified by a community member. For instance, in a security application, the issuing agency might only want subscribers of a given security clearance to receive an alert. As such, if a BOLO alert for a missing child is issued for community members 130a, 130b, 130c, 130d, 130e, 130f, 130g that have a security clearance of High, then only those community members having a security level of at least High will receive the alert regardless of other criteria.

The BOLO alerts previously described are sent to the BOLO subscribers and potentially to other LEAs. Since these BOLO alerts are sent to the community they are defined as front end alerts. In one embodiment, back end alerts may be issued as well. A back end alert or all points bulletin (APB or E-APB) is an alert that is only sent to other LEAs. Any of the alerts discussed as BOLO alerts may be sent as APB alerts by simply limiting the recipients of the alert to other LEAS. Other contemplated APB alerts include terrorist alerts, homeland security alerts, secure information (sent to LEAs or LEA personnel at LEAs based on their respective security clearance), or other types of alerts that are not desired to be disseminated to the community 130.

In one example, back end alerts are used as a training tool. A training alert is sent to a selected group of personnel to test the personnel on law enforcement concepts and/or to provide test scenarios both of which might require the personnel to respond to the alert with an answer or proposed disposition or investigation plan.

In another embodiment, information systems 100, 100′ and 200 include a crime reporting capability wherein members of community 130, 230a, 230b are able to report crimes or suspicious activity to various LEAs 104, 106, 108 through information systems 100, 100′ and 200 either anonymously or with contact information.

In an anonymous example, a community member accesses a web page (not shown) that is generated by information systems 100, 100′ and 200 to report a crime or suspicious activity. The web page includes an identifier that is unique to that particular web page, such as a counter, for the person to note for future reference. The web page further includes fields for the community member to specify information related to the crime or suspicious activity, such as “Address of the crime”, “City of the crime”, “State of the crime”, “Crime Type”, and “Crime Description”. Information systems 100, 100′ and 200 create a record in an Anonymous Reported Crimes database (not shown) based on the information provided. In one example, information systems 100, 100′ and 200 generates a back end alert to LEAs within the area or jurisdiction defined by the information provided.

In a non-anonymous example, a community member accesses a web page (not shown) that is generated by information systems 100, 100′ and 200 to report a crime or suspicious activity. The web page includes fields for the community member to specify information related to the crime or suspicious activity, such as “Agency to Report Crime To”, “Crime Type”, “Crime Description”, “Vehicle Information”, and “Contact Information”. Information systems 100, 100′ and 200 create a record in a Non-anonymously Reported Crimes database (not shown) based on the information provided. In one example, information systems 100, 100′ and 200 generates a back end alert to the specified LEAs. In another example, the community member further includes information for fields “Address of the crime”, “City of the crime”, “State of the crime”, and information systems 100, 100′ and 200 generates a back end alert to the LEAs within the area or jurisdiction defined by the information provided.

Although the invention has been described in detail with reference to certain illustrated embodiments, variations and modifications exist within the scope and spirit of the present invention as defined in the following claims.

We claim:

1. A method for issuing alerts to a plurality of subscribers, each of the subscribers having access to at least one network, the alert being issued by at least one of a plurality of law enforcement agencies, each of the plurality of law enforcement agencies having a computing device configured to share information over the at least one network, the method comprising the steps of:
providing a computing device adapted to share information over the at least network, the computing device configured to access a plurality of databases including information provided by the plurality of law enforcement agencies over the at least one network;
receiving alert information including an alert criteria from at least one of the plurality of law enforcement agencies over the at least one network;
determining which subscribers of the plurality of subscribers are to receive the alert information based on the alert criteria; and
providing an alert to the subscribers of the plurality of subscribers whom were determined to receive the alert information based on the alert criteria.

2. The method of claim 1, wherein the alert criteria is specified by the respective subscriber.

3. The method of claim 1, wherein the alert criteria is specified by the respective law enforcement agency which provided the alert information.

4. The method of claim 2, wherein the alert criteria is selected from the group of geographical criteria, temporal criteria, and event criteria.

5. The method of claim 3, wherein the alert criteria is selected from the group of geographical criteria, temporal criteria, and event criteria.

6. An information system for issuing alerts to a plurality of subscribers, each of the subscribers having access to a network, the plurality of subscribers including a first group of subscribers associated with a first law enforcement agency and a second group of subscribers associated with a second law enforcement agency, the first and second law enforcement agencies including first and second computing devices, respectively, the information system comprising:
at least a third computing device adapted to share information over the network;
a plurality of databases accessible by the at least third computing device, each database including one or more records, the plurality of databases including a subscriber member database, including subscriber records related to the plurality of subscribers, each subscriber record including at least one subscriber contact address and at least one subscriber group designator; and
an information management system configured to be executed by the at least third computing device, the information management system comprising:
a login component configured to receive login information provided across the network from at least one of the first law enforcement agency and the second law enforcement agency and to compare the received login information to one or more user records associated with authorized personnel of at least one of the first law enforcement agency and the second law enforcement agency in a user information database to determine if the login information corresponds to at least one of the user records associated with authorized personnel of at least one of the first law enforcement agency and the second law enforcement agency;
a data input component configured to receive alert data provided across the network from at least one of the first law enforcement agency and the second law enforcement agency; and
an alert component configured to create an alert to be sent to subscribers which satisfy an alert criteria, the alert containing information related to the alert data provided across the network from at least one of the first law enforcement agency and the second law enforcement agency.

7. The information system of claim 6, wherein the alert criteria is specified by the respective subscriber.

8. The information system of claim 6, wherein the alert criteria is specified by the respective law enforcement agency which provided the alert information.

9. The information system of claim 7, wherein the alert criteria is selected from the group of geographical criteria, temporal criteria, and event criteria.

10. The information system of claim 8, wherein the alert criteria is selected from the group of geographical criteria, temporal criteria, and event criteria.

11. The information system of claim 6, wherein the alert criteria is a designator identifying one of the first law enforcement agency and the second law enforcement agency such that the alert is sent to the first group of subscribers when the designator identifies the first law enforcement agency and is sent to the second group of subscribers when the designator identifies the second law enforcement agency.

12. The information system of claim 10, wherein the geographical criteria is defined as a circle whose center is the location of one of an accident or a crime.

13. The information system of claim 12, wherein the radius of the circle is set to a distance a suspect of the crime is believed to be within.

14. The information system of claim 6, wherein the alert is sent to each subscriber satisfying the alert criteria at the at least one subscriber contact address provided in the subscriber member database.

15. The information system of claim 14, wherein the subscriber contact address is selected from a telephone number, an e-mail address, a pager number, a fax number, and a network address.

16. An information system for sharing of information between a plurality of law enforcement agencies, including a first law enforcement agency having a first computing device and a second law enforcement agency having a second computing device, both the first and second computing devices being configured to share information over at least one network, the information system, comprising:
at least a third computing device adapted to share information over the at least one network;
a plurality of databases accessible by the third computing device, each database including one or more records; and
an information management system configured to be executed by the at least third computing device, the information management system comprising:
a login component configured to receive login information provided across the at least one network and to compare the received login information to one or more user records in a user information database to determine if the login information corresponds to at least one of the user records;
a data input component configured to receive data provided across the at least one network and to create or update the one or more records of one or more of the plurality of databases based on the received information; and
a data searching component configured to receive a request containing search criteria provided across the network and configured to search one or more databases of the plurality of databases, the databases created or updated with the data input component based on information provided by the plurality of law enforcement agencies, for one or more records that satisfy the search criteria of the request, and to provide at least a portion of the information related to the one or more records.

17. The information system of claim 16, wherein the information related to the one or more records is provided as a web page generated by the information management system.

18. The information system of claim 16, wherein the data input component generates a data input form in response to receiving a request across the at least one network for the creation of a new record in at least one of the plurality of databases from one of the plurality of law enforcement agencies.

19. The information system of claim 16, wherein the plurality of databases includes at least one of a missing persons database, a missing children database, and a wanted persons database.

20. The information system of claim 16, wherein the plurality of databases includes a criminal profiling database including one or more records, wherein the first law enforcement provides information related to a type of crime in a first record and the second law enforcement agency provides additional information related to the type of crime, the additional information being associated with the first record.

21. A method for searching information related to at least one of a plurality of law enforcement agencies, including a first law enforcement agency having a first computing device and a second law enforcement agency having a second computing device, both the first and second computing devices being configured to provide and receive information over a network, the method comprising the steps of:
connecting a third computing device to the network;
providing a plurality of databases accessible by the third computing device and including a user information database, each database including one or more records created or modified based on information received from the first computing device and the second computing device;
receiving a request from at least one of the first computing device and the second computing device containing search criteria provided across the network;
searching the records created or modified based on information received from the first computing device and the second computing device of at least one of the plurality of databases for one or more records that satisfy the search criteria of the request; and
providing at least a portion of the information related to the one or more records to the at least one of the first computing device and the second computing device that generated the request.

22. The method of claim 21, wherein the one or more records in at least one of the plurality of databases is created by the a method comprising the steps of:
receiving login information provided across the network from either the first computing device or the second computing device;
comparing the received login information to one or more user records in the user information database to determine if the login information corresponds to at least one of the user records;
receiving a request to create a new record in a first database of the plurality of databases, the first database including records created based on information received from the first computing device and the second computing device;
providing a data input mechanism configured to receive information related to the new record;
receiving the information related to the new record provided to the data input mechanism;
verifying that the information related to the new record satisfies a defined record structure of the first database; and
updating the first database to include the new record.

23. The method of claim 21, wherein the provided portion of the information related to the one or more records is provided as a web page.

24. The method of claim 22, wherein the data input mechanism is a data input form, the data input form being configured to obtain information for the defined database structure of the first database.

25. The method of claim 21, wherein at least one of the plurality of databases is searchable across the network by a fourth computing device not affiliated with the plurality of law enforcement agencies.
